(19) United States
(12) Patent Application Publication
(10) Pub. No.: US 2026/0072839 A1
(43) Pub. Date: Mar. 12, 2026

(54) TECHNIQUES FOR DIRECTORY-ORDERED RELEASE CONSISTENCY

(71) Applicant: NVIDIA CORPORATION, Santa Clara, CA (US)

(72) Inventors: Nicolai Alexander OSWALD, San Jose, CA (US); Gonzalo Brito GADESCHI, Munich (DE); Guillermo Juan ROZAS, Los Gatos, CA (US); Yanpeng YU, New Haven, CT (US)

(21) Appl. No.: 19/304,350

(22) Filed: Aug. 19, 2025

Related U.S. Application Data
(60) Provisional application No. 63/693,063, filed on Sep. 10, 2024.
(60) Provisional application No. 63/752,589, filed on Jan. 31, 2025.

(51) Int. Cl. G06F 12/0811

(52) U.S. Cl. CPC G06F 12/0811; G06F 2212/1008

(57) ABSTRACT

Various embodiments include techniques for inter-processor communication. The techniques include generating a relaxed store message that comprises a first epoch number, incrementing a first counter associated with the first epoch number, and transmitting the relaxed store message to a first directory included in a cache.

### CROSS-REFERENCE TO RELATED APPLICATIONS

This application claims priority benefit of the United States Provisional Patent Application titled, “TECHNIQUES FOR DIRECTORY-ORDERED RELEASE CONSISTENCY,” filed on Sep. 10, 2024, and having Ser. No. 63/693,063, and the United States Provisional Patent Application titled, “TECHNIQUES FOR DIRECTORY-ORDERED RELEASE CONSISTENCY,” filed on Jan. 31, 2025, and having Ser. No. 63/752,589. The subject matter of these related applications are hereby incorporated herein by reference.

### BACKGROUND

### Technical Field

Various embodiments relate generally to computer science and computer architecture and, more specifically, to techniques for directory-ordered release consistency.

### Description of the Related Art

Computing systems that include multiple processing units, such a central processing unit (CPU) and a graphics processing unit (GPU), multiple CPUs, multiple GPUs, and/or the like, are becoming increasingly common. One approach for the multiple processing units (e.g., CPU-GPU, multi-CPU, multi-GPU, etc.) in a computing system to communicate is through cache-coherent shared memory. A cache-coherent shared memory ensures that all processors or cores maintain a consistent view of shared memory, even when multiple caches store copies of the same data. Cache-coherent shared memories implement cache coherence protocols that include rules for ensuring data consistency across multiple caches.

Release consistency is a memory consistency model that works on top of cache coherence protocols to ensure correct ordering and visibility of memory accesses in concurrent systems. Release consistency is a relaxed memory model that allows most reads and writes of data from memory to be reordered so long as synchronization operations are respected. Release consistency uses two types of operations: (1) ordinary reads and writes are allowed to be reordered for performance, and (2) synchronization operations that act as “fences” to control visibility between computing threads. Two types of synchronization operations are release operations and acquire operations. Release operations are performed after updating shared data, ensuring that all previous memory operations that write data (and in some implementations also read operations) are completed, and the written data is therefore visible, before the release becomes visible. Acquire operations are performed before accessing shared data, ensuring that subsequent memory reads and writes cannot be reordered before the acquire operations.

One approach for implementing release consistency is source ordering. In source ordering, the source must control the sequence in which memory accesses become globally visible. Data can be written at the local or remote cache. For example, in the case of remote writes, Source ordering requires a directory in a cache that receives ordinary requests to write data, which are referred to as “relaxed” write requests, to acknowledge each of the relaxed write requests after data from the relaxed write requests is successfully written into the cache. A source processor that transmitted the relaxed write requests keeps track of acknowledgement messages from the cache directory. The source processor only performs the release store by transmitting a release request that is fulfilled by a release operation after all previously transmitted relaxed write requests (and, depending on the instruction set architecture (ISA) memory consistency model, also pending reads) have been acknowledged. In a system, there may be different release stores with different ordering guarantees with respect to preceding loads and stores.

One drawback of source ordering is the repeated transmission of acknowledgement messages results in a significant amount of communication between the source processor and the cache directory. Communication between the source processor and the cache directory takes time, and the delays caused by such communication are referred to as “latency.” The latency caused by source ordering can significantly impact the performance of a computing system. In addition, the communication between the source processor and the cache directory that is required by source ordering increases the interconnect traffic and energy consumption of the computing system.

As the foregoing illustrates, what is needed in the art are more effective techniques for communication between processing units within computing systems.

### SUMMARY

One embodiment of the present disclosure sets forth a method for inter-processor communication. The method includes generating a relaxed store message that comprises a first epoch number. The method further includes incrementing a first counter associated with the first epoch number. In addition, the method includes transmitting the relaxed store message to a first directory included in a cache.

One embodiment of the present disclosure sets forth a method for inter-processor communication. The method includes receiving a relaxed store message that comprises a first epoch number. The method further includes performing a relaxed store operation based on the relaxed store message. In addition, the method includes incrementing a first counter associated with the first epoch number.

Other embodiments include, without limitation, a system that implements one or more aspects of the disclosed techniques, and one or more computer readable media including instructions for performing one or more aspects of the disclosed techniques.

At least one technical advantage of the disclosed techniques relative to the prior art is that the disclosed techniques use directory ordering to reduce the number of messages that are transmitted between source and destination components of a computing system in order to implement release consistency. The reduced number of messages results in lower latency relative to source ordering, improving the overall performance of the computing system. The reduced number of messages also reduces the interconnect traffic and energy consumption of the computing system. In addition, directory ordering enables scalable release consistency semantics across multiple directories, including directories in a hierarchy. Another technical advantage of disclosed techniques is that, leveraging heuristics, a processor may switch at any time between source and directory ordering without breaking coherence and violating memory consistency and henceforth correctness. In particular, different instructions can be implemented in the processor to expose different behaviors to a programmer, such as store-remote-non-posted (for non-posted write, a CPU receives acknowledgment to perform source ordering) or store-remote-posted (no acknowledgment sent to a CPU because of destination ordering). Such a mechanism extends state of the art coherence protocols that use source ordering to support directory ordering. These technical advantages provide one or more technological improvements over prior art approaches.

### BRIEF DESCRIPTION OF THE DRAWINGS

So that the manner in which the features of the various embodiments recited herein can be understood in detail, a more particular description of the inventive concepts, briefly summarized herein, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the parallel processing subsystem of FIG. 1, according to various embodiments;

FIG. 3 is a block diagram of a general processing cluster (GPC) included in the parallel processing unit of FIG. 2, according to various embodiments;

FIG. 4 illustrates exemplar communications between the central processing unit (CPU) and the parallel processing subsystem of FIG. 1, according to various embodiments;

FIG. 5 is a more detailed illustration of one of the processor cores of the CPU of FIG. 4, according to various embodiments;

FIG. 6 is a more detailed illustration of one of the L2 slices of the L2 cache of FIG. 4, according to various embodiments;

FIG. 7 illustrates how directory ordering enforces an ordering between a relaxed store and a subsequent release store hosted by the same directory, according to various embodiments;

FIG. 8 illustrates how directory ordering enforces an ordering between two release stores at the same directory, according to various embodiments;

FIG. 9 illustrates how inter-directory notification enables release-consistent ordering between a relaxed store and a subsequent release store at two different directories, according to various embodiments;

FIG. 10 illustrates an exemplar hierarchy of source and destination components that implements directory-ordered release consistency, according to various embodiments;

FIG. 11 illustrates how combined source-ordered and directory-ordered release consistency can be implemented, according to various embodiments;

FIG. 12 is a flow diagram of method steps for transmitting a relaxed store message, according to various embodiments;

FIG. 13 is a flow diagram of method steps for transmitting a release store message, according to various embodiments;

FIG. 14 is a flow diagram of method steps for processing a release store acknowledgement message, according to various embodiments;

FIG. 15 is a flow diagram of method steps for processing a relaxed store message, according to various embodiments;

FIG. 16 is a flow diagram of method steps for processing a release store message, according to various embodiments;

FIG. 17 is a flow diagram of method steps for processing a request for notification message, according to various embodiments; and

FIG. 18 is a flow diagram of method steps for processing a notification message, according to various embodiments.

### DETAILED DESCRIPTION

In the following description, numerous specific details are set forth to provide a more thorough understanding of the various embodiments. However, it will be apparent to one skilled in the art that the inventive concepts can be practiced without one or more of these specific details.

Embodiments of the present disclosure provide techniques for directory-ordered release consistency. Unlike source ordering, which orders stores at the source component (e.g., a processor or processor core) using acknowledgments to enforce release consistency, directory ordering directly orders stores at the destination component (e.g., a cache directory). In some embodiments, a source component, such as a processor core or processor, stores (1) for purposes of source ordering, a counter of outstanding source order requests, and (2) for purposes of directory ordering, source data structures that include a current epoch number, store counters for each directory in a current epoch, and last unacknowledged epoch numbers for each directory. Each destination component, such as, for example, a level 2 (L2) cache slice, includes a directory that stores, for purposes of directory ordering, a counter for each source component and each epoch associated with the source component, a largest committed epoch for each source component, and a notification counter for each source component and each epoch associated with the source component. For directory ordering, a source component can transmit data to one or more directories using relax and release store operations, according to the release consistency memory model. Epochs, which are tracked by the source component using the current epoch number, divide logical time into periods between release stores. During each epoch, the source component transmits, to each directory (or a subset of the directories), multiple relaxed store messages and a single release store message. As used herein, “relaxed store messages” and “release store messages” refer to directory ordered relaxed store messages and release store messages, respectively, unless specified otherwise, such as when referred to as “source ordered relaxed store messages” or “source ordered release store messages.” Each relaxed store message includes data to write and the current epoch number. The release store message includes data to write, the current epoch number, and a count of the number of relaxed store messages that need to be committed by the directory, which is tracked by the directory using the store counter described above, before the release store is committed. If the store counter of the directory indicates that fewer than the count number of relaxed store messages have been committed, then some relaxed store messages may still be in flight, and the directory will stall the release store message and retry later, such as after a predefined period of time or if a counter (e.g., the relaxed store counter) of the epoch is updated. When there are multiple directories, such as multiple directories in different L2 slices of an L2 cache, an inter-directory notification mechanism permits the directories to directly notify each other of the completion of certain stores, thereby enforcing cross directory ordering without involving the source component. More specifically, when issuing a release store to one of the multiple directories (also referred to herein as a “destination directory”), the source component also embeds, in addition to the epoch number, store counter, and the last prior unacknowledged epoch number (as described above), a notification counter that indicates the number of other directories (also referred to herein as “pending directories”) that either has one or more pending relaxed store(s) in the current epoch or has one or more unacknowledged release store(s). The notification counter indicates to the destination directory that the current release store should not be committed before notifications from all pending directories are received. Concurrent with transmitting the release store message, the source component transmits a request for notification message to each pending directory. The request for notification message includes (1) the number of relaxed stores in the current epoch for the pending directory, (2) the last unacknowledged epoch for the pending directory, (3) the current epoch number, and (4) the destination directory. The request for notification message requests that the pending directory notify the destination directory after the pending directory commits all pending stores. After receiving such a request for notification, the pending directory will transmit a notification to the destination directory after the pending directory commits all the pending stores as embedded and the previous epoch equals the last unacknowledged epoch. Then, the destination directory commits the release store only after the collected number of such notifications from pending directories for the source component and epoch number equals the notification counter embedded in the release store message and the destination directory's previous epoch equals the last unacknowledged epoch, thereby ensuring that a release store will not be committed until all prior stores (and releases) at other directories have been committed, which ensures release consistency.

The techniques for directory-ordered release consistency have many real-world applications. For example, these techniques can be used in multi-processing unit systems (e.g., multi-central processing unit (CPU), multi-graphics processing unit (GPU), CPU-GPU, etc.) to implement cache-coherent shared memory.

The above examples are not in any way intended to be limiting. As persons skilled in the art will appreciate, as a general matter, the techniques for directory-ordered release consistency that are described herein can be implemented in any application where cache-coherent shared memory is required or useful.

### System Overview

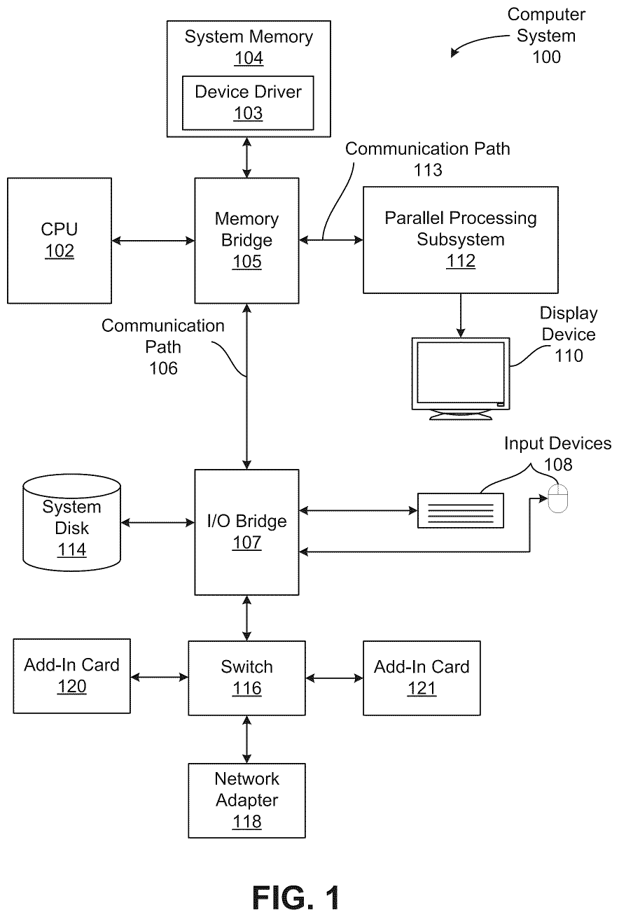

FIG. 1 is a block diagram of a computing system 100 configured to implement one or more aspects of the various embodiments. As shown, computing system 100 includes, without limitation, a central processing unit (CPU) 102 and a system memory 104 coupled to a parallel processing subsystem 112 via a memory bridge 105 and/or a communication path 113. Memory bridge 105 is further coupled to an I/O (input/output) bridge 107 via a communication path 106, and/or I/O bridge 107 is, in turn, coupled to a switch 116.

In operation, I/O bridge 107 is configured to receive user input information from input devices 108, such as a keyboard or a mouse, and/or forward the input information to CPU 102 for processing via communication path 106 and/or memory bridge 105. Switch 116 is configured to provide connections between I/O bridge 107 and/or other components of the computing system 100, such as a network adapter 118 and/or various add-in cards 120 and 121. In some examples, without limitation, network adapter 118 serves as the primary or exclusive input device to receive input data for processing via the disclosed techniques.

As also shown, I/O bridge 107 is coupled to a system disk 114 that can be configured to store content and/or applications and/or data for use by CPU 102 and/or parallel processing subsystem 112. As a general matter, system disk 114 provides non-volatile storage for applications and/or data and can include fixed or removable hard disk drives, flash memory devices, and/or CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and/or the like, can be connected to I/O bridge 107 as well.

In various embodiments, memory bridge 105 can be a Northbridge chip, and/or I/O bridge 107 can be a Southbridge chip. In addition, communication paths 106 and/or 113, as well as other communication paths within computing system 100, can be implemented using any technically suitable protocols, including, without limitation, Peripheral Component Interconnect Express (PCIe), HyperTransport, or any other bus or point-to-point communication protocol known in the art.

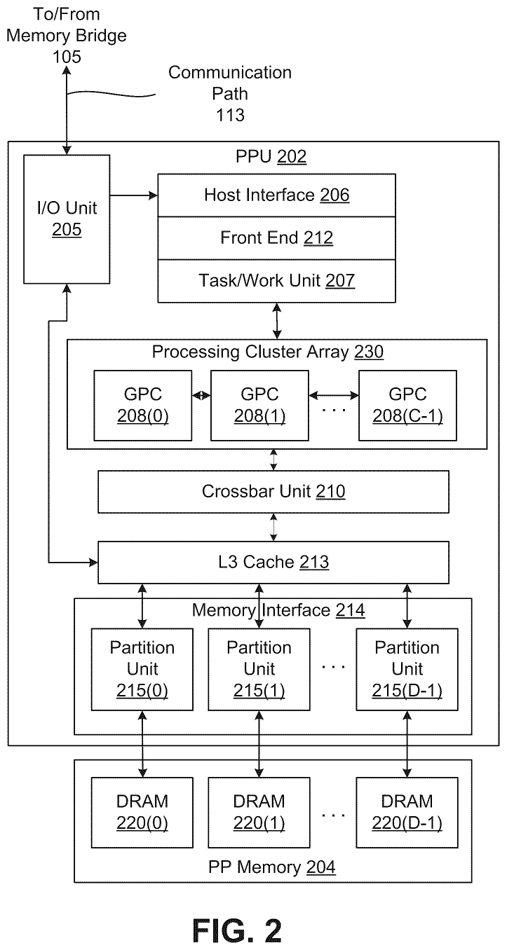

In some embodiments, parallel processing subsystem 112 comprises a graphics subsystem that delivers pixels to a display device 110 that can be any conventional cathode ray tube, liquid crystal display, light-emitting diode display, or the like. In such embodiments, the parallel processing subsystem 112 incorporates circuitry optimized for graphics and/or video processing, including, for example, without limitation, video output circuitry. As described in greater detail herein in FIG. 2, such circuitry can be incorporated across one or more parallels included within parallel processing subsystem 112. Parallel processing subsystem 112 includes one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, parallel processing subsystem 112 includes two processors, referred to herein as a primary processor (normally a CPU) and/or a secondary processor. Typically, the primary processor is a CPU and/or the secondary processor is a GPU. Additionally or alternatively, each of the primary processor and/or the secondary processor can be any one or more of the types of parallels disclosed herein, in any technically feasible combination. The secondary processor receives secure commands from the primary processor via a communication path that is not secured. The secondary processor accesses a memory and/or other storage system, such as system memory 104, Compute eXpress Link (CXL) memory expanders, memory managed disk storage, on-chip memory, and/or the like. The secondary processor accesses this memory and/or other storage system across an insecure connection. The primary processor and/or the secondary processor can communicate with one another via a GPU-to-GPU communications channel, such as Nvidia Link (NVLink). Further, the primary processor and/or the secondary processor can communicate with one another via network adapter 118. In general, the distinction between an insecure communication path and/or a secure communication path is application dependent. A particular application program generally considers communications within a die or package to be secure. Communications of unencrypted data over a standard communications channel, such as PCIe, are considered to be unsecure.

In some embodiments, the parallel processing subsystem 112 incorporates circuitry optimized for general purpose and/or compute processing. Again, such circuitry can be incorporated across one or more parallel processing units included within parallel processing subsystem 112 that are configured to perform such general purpose and/or compute operations. In yet other embodiments, the one or more parallel processing units included within parallel processing subsystem 112 can be configured to perform graphics processing, general purpose processing, and/or compute processing operations. System memory 104 includes at least one device driver 103 configured to manage the processing operations of the one or more parallels within parallel processing subsystem 112.

In various embodiments, parallel processing subsystem 112 can be integrated with one or more of the other elements of FIG. 1 to form a single system. For example, without limitation, parallel processing subsystem 112 can be integrated with CPU 102 and/or other connection circuitry on a single chip to form a system on chip (SoC).

It will be appreciated that the system shown herein is illustrative and that variations and/or modifications are possible. The connection topology, including the number and/or arrangement of bridges, the number of CPUs 102, and/or the number of parallel processing subsystems 112, can be modified as desired. For example, without limitation, in some embodiments, system memory 104 can be connected to CPU 102 directly rather than through memory bridge 105, and/or other devices would communicate with system memory 104 via memory bridge 105 and/or CPU 102. In other alternative topologies, parallel processing subsystem 112 can be connected to I/O bridge 107 or directly to CPU 102, rather than to memory bridge 105. In still other embodiments, I/O bridge 107 and/or memory bridge 105 can be integrated into a single chip instead of existing as one or more discrete devices. Lastly, in certain embodiments, one or more components shown in FIG. 1 can not be present. For example, without limitation, switch 116 can be eliminated, and/or network adapter 118 and/or add-in cards 120, 121 would connect directly to I/O bridge 107.

FIG. 2 is a block diagram of a parallel processing unit (PPU) 202 included in the parallel processing subsystem 112 of FIG. 1, according to various embodiments. Although FIG. 2 depicts one PPU 202, as indicated herein, parallel processing subsystem 112 can include any number of PPUs 202. Further, the PPU 202 of FIG. 2 is one non-limiting example of a parallel included in parallel processing subsystem 112 of FIG. 1. Alternative parallels include, without limitation, CPUs, GPUs, DMA units, IPUs, NPUs, TPUs, NNPs, DPUs, VPUs, ASICS, FPGAs, and/or the like. The techniques disclosed in FIGS. 2-4 with respect to PPU 202 apply equally to any type of parallel(s) included within parallel processing subsystem 112, in any combination. As shown, PPU 202 is coupled to a local parallel processing (PP) memory 204. PPU 202 and/or PP memory 204 can be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that can be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 can be used to store and/or update pixel data and/or deliver final pixel data or display frames to display device 110 for display. In some embodiments, PPU 202 also can be configured for general-purpose processing and/or compute operations.

In operation, CPU 102 is the master processor of computing system 100, controlling and/or coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that can be located in system memory 104, PP memory 204, or another storage location accessible to both CPU 102 and/or PPU 202. Additionally or alternatively, processors and/or processing units other than CPU 102 can write one or more streams of commands for PPU 202 to a data structure. A pointer to the data structure is written to a pushbuffer to initiate processing of the stream of commands in the data structure. The PPU 202 reads command streams from the pushbuffer and/or then executes commands asynchronously relative to the operation of CPU 102. In embodiments where multiple pushbuffers are generated, execution priorities can be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and/or memory bridge 105. I/O unit 205 generates packets (or other signals) for transmission on communication path 113 and/or also receives all incoming packets (or other signals) from communication path 113, directing the incoming packets to appropriate components of PPU 202. For example, without limitation, commands related to processing tasks can be directed to a host interface 206, while commands related to memory operations (e.g., reading from or writing to PP memory 204) can be directed to a crossbar unit 210. Host interface 206 reads each pushbuffer and/or transmits the command stream stored in the pushbuffer to a front end 212.

As mentioned herein in conjunction with FIG. 1, the connection of PPU 202 to the rest of computing system 100 can be varied. In some embodiments, parallel processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 can be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and/or stored in memory. The pointers to TMDs are included in a command stream that is stored as a pushbuffer and received by front end 212 from host interface 206. Processing tasks that can be encoded as TMDs include indices associated with the data to be processed as well as state parameters and/or commands that define how the data is to be processed. For example, without limitation, the state parameters and/or commands can define the program to be executed on the data. Task/work unit 207 receives tasks from front end 212 and/or ensures that GPCs 208 are configured to a valid state before the processing task specified by each one of the TMDs is initiated. A priority can be specified for each TMD that is used to schedule the execution of the processing task. Processing tasks also can be received from processing cluster array 230. Optionally, the TMD can include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 can be allocated for processing different types of programs or for performing different types of computations. The allocation of GPCs 208 can vary depending on the workload arising for each type of program or computation. As will be described in more detail herein, one or more GPCs 208 can concurrently execute threads in a cooperative thread array (CTA) that cooperate and share data to perform collective computations.

In the illustrated example of FIG. 2, PPU 202 further includes a level three (L3) cache memory, or L3 cache, 213. As will be described in more detail herein, L3 cache 213 is shared by GPCs 208 included in PPU 202. In a cache hierarchy, L3 cache 213 is positioned further upstream from streaming multiprocessors (SMs) executing threads than level one (L1) and level two (L2) caches included in PPU 202. In some examples, such as in the illustrated example of FIG. 2, L3 cache 213 is the highest level cache (HLC) in a cache hierarchy. In some examples, PPU 202 and/or parallel processing subsystem 112 includes one or more additional levels of cache (e.g., level four (L4) cache, level five (L5) cache, etc.) that are positioned further upstream in a cache hierarchy. In some examples, the PPU does not include an L3 cache 213. In such examples, the L2 caches included in the PPU 202 are at the highest level of cache in the PPU 202 and/or parallel processing subsystem 112.

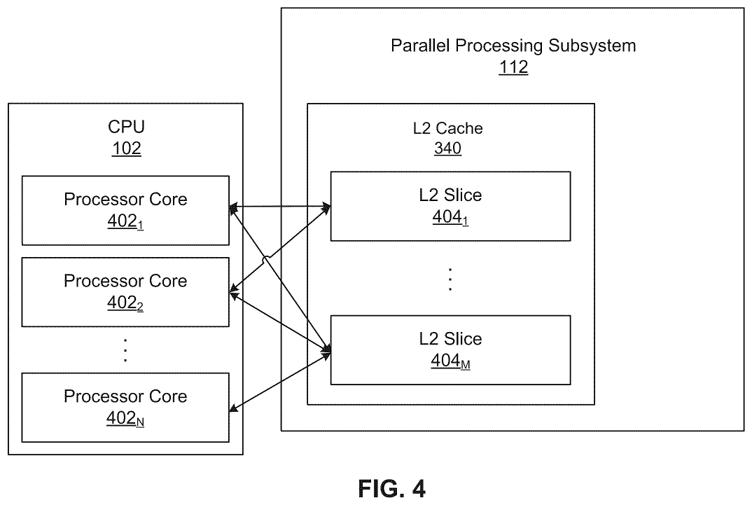

L3 cache 213 is coupled to a memory interface 214. Memory interface 214 includes a set D of partition units 215, where D≥1. Each partition unit 215 is coupled to one or more dynamic random access memories (DRAMs) 220 residing within PP memory 204. In one embodiment, the number of partition units 215 equals the number of DRAMs 220, and/or each partition unit 215 is coupled to a different DRAM 220. In other embodiments, the number of partition units 215 can be different than the number of DRAMs 220. In some embodiments, one or more caches, such as L3 cache 213, can also be partitioned. For example, every L3 cache partition could handle read and write accesses for a specific address range. In such cases, a scope tree, discussed in greater detail below in conjunction with FIGS. 4-19, can be created for each address range.

Persons of ordinary skill in the art will appreciate that a DRAM 220 can be replaced with any other technically suitable storage device. In operation, various render targets, such as texture maps and/or frame buffers, can be stored across DRAMs 220, allowing partition units 215 to write portions of each render target in parallel to efficiently use the available bandwidth of PP memory 204.

A given GPC 208 can process data to be written to any of DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 can use virtual channels to separate traffic streams between the GPCs 208 and/or partition units 215.

Again, GPCs 208 can be programmed to execute processing tasks relating to a wide variety of applications, including, without limitation, linear and/or nonlinear data transforms, filtering of video and/or audio data, modeling operations (e.g., applying laws of physics to determine position, velocity, and/or other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and/or write result data back to system memory 104 and/or PP memory 204. The result data can then be accessed by other system components, including CPU 102, another PPU 202 within parallel processing subsystem 112, or another parallel processing subsystem 112 within computing system 100.

As noted herein, any number of PPUs 202 can be included in a parallel processing subsystem 112. For example, without limitation, multiple PPUs 202 can be provided on a single add-in card, or multiple add-in cards can be connected to communication path 113, or one or more of PPUs 202 can be integrated into a bridge chip. PPUs 202 in a multi-PPU system can be identical to or different from one another. For example, without limitation, different PPUs 202 might have different numbers of processing cores and/or different amounts of PP memory 204. In implementations where multiple PPUs 202 are present, those PPUs can be operated in parallel to process data at a higher throughput than is possible with a single PPU 202. Systems incorporating one or more PPUs 202 can be implemented in a variety of configurations and/or form factors, including, without limitation, desktops, laptops, handheld personal computers or other handheld devices, servers, workstations, game consoles, embedded systems, and/or the like.

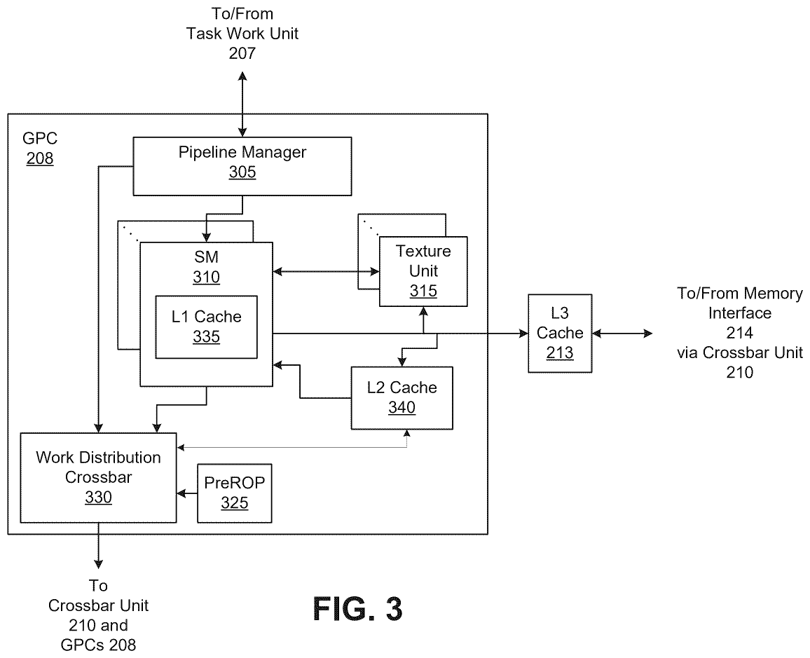

FIG. 3 is a block diagram of a general processing cluster (GPC) 208 included in the parallel processing unit (PPU) 202 of FIG. 2, according to various embodiments. In operation, GPC 208 can be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 can also be configured to control a work distribution crossbar 330 by specifying destinations for processed data output by SMs 310.

In one embodiment, GPC 208 includes a set of Q SMs 310, where Q≥1. Also, each SM 310 includes a set of functional execution units (not shown), such as execution units and/or load-store units. Processing operations specific to any of the functional execution units can be pipelined, which enables a new instruction to be issued for execution before a previous instruction has completed execution. Any combination of functional execution units within a given SM 310 can be provided. In various embodiments, the functional execution units can be configured to support a variety of different operations including integer and/or floating point arithmetic (e.g., addition and/or multiplication), comparison operations, Boolean operations (e.g., AND, OR, XOR), bit-shifting, and/or computation of various algebraic functions (e.g., planar interpolation and/or trigonometric, exponential, and/or logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group can include fewer threads than the number of execution units within SM 310, in which case some of the execution can be idle during cycles when that thread group is being processed. A thread group can also include more threads than the number of execution units within SM 310, in which case processing can occur over consecutive clock cycles and/or across multiple SMs 310. Since each SM 310 can support up to G thread groups concurrently, it follows that up to G*Q thread groups can be executing in GPC 208 at any given time.

Additionally, a plurality of related thread groups can be active (in different phases of execution) at the same time within one or more SMs 310. This collection of thread groups is referred to herein as a “cooperative thread array” (“CTA”) or “thread array.” The size of a particular CTA is equal to q*k, where k is the number of concurrently executing threads in a thread group, which is typically an integer multiple of the number of execution units within SM 310, and q is the number of thread groups simultaneously active within the one or more SMs 310. In various embodiments, a software application written in the compute unified device architecture (CUDA) programming language describes the behavior and/or operation of threads executing on GPC 208, including any of the behaviors and/or operations described herein. A given processing task can be specified in a CUDA program such that SM 310 can be configured to perform and/or manage general-purpose compute operations.

As will be described in more detail herein, each SM 310 is coupled to a private level one (L1) cache memory, or L1 cache, 335 that supports, among other things, load and/or store operations performed by the execution units. Each SM 310 in a particular GPC 208 also has access to a level two (L2) cache, or L2 cache, 340 that is shared among all SMs 310 in the particular GPC 208 and L3 cache 213 that is shared among GPCs 208 in PPU 202. L2 caches 340 and L3 cache 213 can be used to transfer data between threads. Persons skilled in the art will understand that the three levels of caches illustrated in FIGS. 2 and 3 are provided as non-limiting examples of cache memory, and that in other examples, a PPU 202 can include and/or be coupled to fewer or more than two levels of cache. In some examples, PPU 202 includes and/or is coupled to two levels of cache memory. In other examples, PPU 202 includes and/or is coupled to four levels of cache memory, five levels of cache memory, or some other number of levels of cache memory.

In addition to various levels of cache memory, SMs 310 also have access to off-chip “global” memory, which can include PP memory 204 and/or system memory 104. It is to be understood that any memory external to PPU 202 can be used as global memory. As shown in FIGS. 2 and 3, L3 cache 213 and/or L2 caches 340 can be configured to receive and/or hold data requested from memory via memory interface 214 by an SM 310. Such data can include, without limitation, instructions, uniform data, and/or constant data. As will be described in more detail herein, each GPC 208 can have an associated memory management unit (MMU) that is configured to map virtual addresses into physical addresses. In various embodiments, MMU can reside either within GPC 208 or within memory interface 214. The MMU includes a set of page table entries (PTEs) used to map a virtual address to a physical address of a tile or memory page and/or optionally a cache line index. The MMU can include address translation lookaside buffers (TLB) or caches that can reside within SMs 310, within one or more L1 caches 335, one or more L2 caches 340, L3 cache 213, and/or within GPC 208. In some examples, the MMU includes or is in addition to the scope tree and coherence protocol controllers described herein with respect to the different levels of cache memory.

In graphics and/or compute applications, GPC 208 can be configured such that each SM 310 is coupled to a texture unit 315 for performing texture mapping operations, such as determining texture sample positions, reading texture data, and/or filtering texture data.

In operation, each SM 310 transmits a processed task to work distribution crossbar 330 in order to provide the processed task to another GPC 208 for further processing or to store the processed task in an L2 cache 340 or an L3 cache 213, parallel processing memory 204, or system memory 104 via crossbar unit 210. In addition, a pre-raster operations (preROP) unit 325 is configured to receive data from an SM 310, direct data to one or more raster operations (ROP) units within partition units 215, perform optimizations for color blending, organize pixel color data, and/or perform address translations.

### Directory-Ordered Release Consistency

FIG. 4 illustrates exemplar communications between CPU 102 and parallel processing subsystem 112 of FIG. 1, according to various embodiments. As shown, CPU 102 includes, without limitation, multiple processor cores 402_{1-N}(referred to herein collectively as processor cores 402 and individually as a processor core 402). Parallel processing subsystem 112 includes, without limitation, L2 cache 340, and L2 cache 340 includes, without limitation, multiple L2 slices 404_{1-M}. (referred to herein collectively as L2 slices 404 and individually as an L2 slice). Illustratively, processor cores 402 are in communication with L2 slices 404. Although described herein primarily with respect to processor cores and L2 slices as a reference example, in some embodiments, directory ordering can be implemented in any source and destination components at any level of granularity, such as a source at a thread granularity, a processor granularity, a cluster of processors granularity, and/or a system node granularity, etc. and a destination that is a memory at some granularity (e.g., L2 slice, L2 cache, multiple remote L2 caches, next level memory in hierarchy L3, etc.). For example, the source component could be a processor (e.g., a CPU or GPU), and the destination component could be a directory of a cache (e.g., an L2 cache) in another processor (e.g., a GPU or CPU). As another example, the source component could be a processor thread, and the destination component could be an L2 slice in another processor. As another example, the source component could be a cluster of processors, and the destination component could be an L2 cache encompassing multiple L2 slices.

As described, computing systems that include multiple processing units (e.g., CPU-GPU, multi-CPU, multi-GPU, etc.), such as CPU 102 and parallel processing subsystem 112, can use cache-coherent shared memory, such as L2 cache 340, to facilitate inter-processing unit communication. In such systems, the coherence protocols include rules for ensuring data consistency across multiple caches, which can support write-back accesses that allocate the written data in the cache closest to the processing unit and write-through accesses that place the data directly at a last-level cache to enable efficient producer-consumer communications. Release consistency is a memory consistency model that works on top of cache coherence protocols to ensure correct ordering and visibility of memory accesses in concurrent systems. Release consistency can be used to support high performance in multi-processing unit systems. Release consistency is a relaxed memory model that allows most reads and writes to be reordered so long as synchronization operations are respected. Release consistency uses two types of operations: (1) ordinary reads and writes that can be reordered for performance, and (2) synchronization operations, such as acquire and release, which act like “fences” to control visibility between threads. “Fence” and “barrier” are used interchangeably herein, and the fencing/barrier of acquiring loads and releasing stores are sometimes referred to as “half barriers” because they fence in one direction but not the other, as opposed to pure barriers that are bidirectional. Acquire operations are performed before accessing shared data, ensuring that subsequent memory reads/writes cannot be reordered before the acquire. Release operations are performed after updating shared data, ensuring that all previous memory operations that read/write data are completed, and the written data is therefore visible, before the release becomes visible. Intuitively, release consistency allows memory accesses or fences to be annotated with acquire, release, acquire-release, or relaxed labels. Stores, atomics, or fences annotated with release serve as barriers that prior memory accesses (in program order) cannot be reordered after. Similarly, loads, atomics, or fences annotated with acquire serve as barriers that subsequent memory accesses (in program order) cannot be ordered before. Finally, while acquire-release accesses serve as a full memory barrier (i.e., no accesses can be reordered before or after acquire-release accesses), relaxed accesses do not have any ordering constraints.

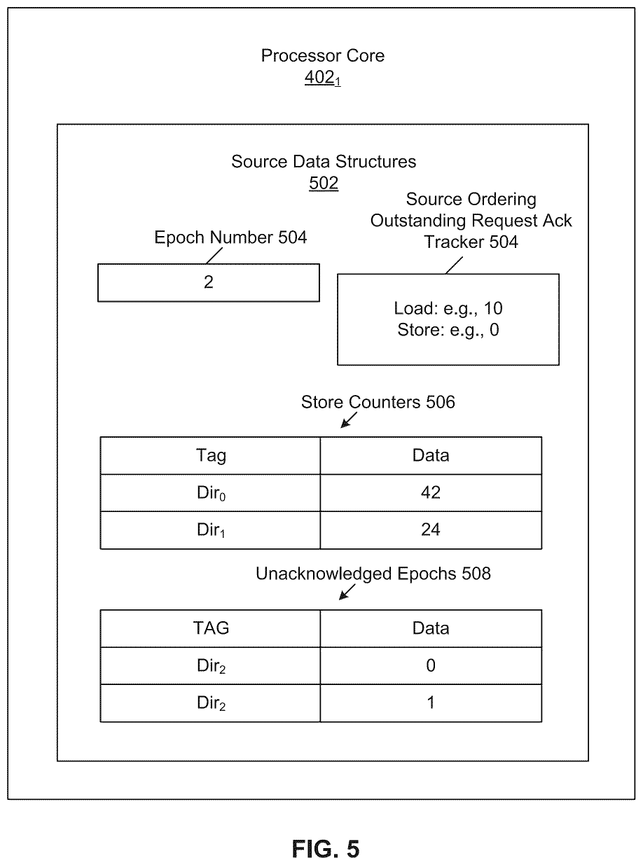

In some embodiments, L2 slices 404 (or other destination components) implement directory-ordered release consistency, discussed in greater detail below in conjunction with FIGS. 5-17. Unlike source ordering, which orders stores at the source component (e.g., a processor or processor core) using acknowledgments to enforce release consistency, directory ordering directly orders stores at the destination component (e.g., a cache directory). In particular, instead of ordering memory accesses at the source component, by waiting for store acknowledgments before a release, directory ordering enforces ordering at the point of coherence (PoC) cache directory using additional transferred and tracked metadata with the data (i.e., epoch numbers, store counters and notification counters), thereby eliminating the need for store acknowledgments.

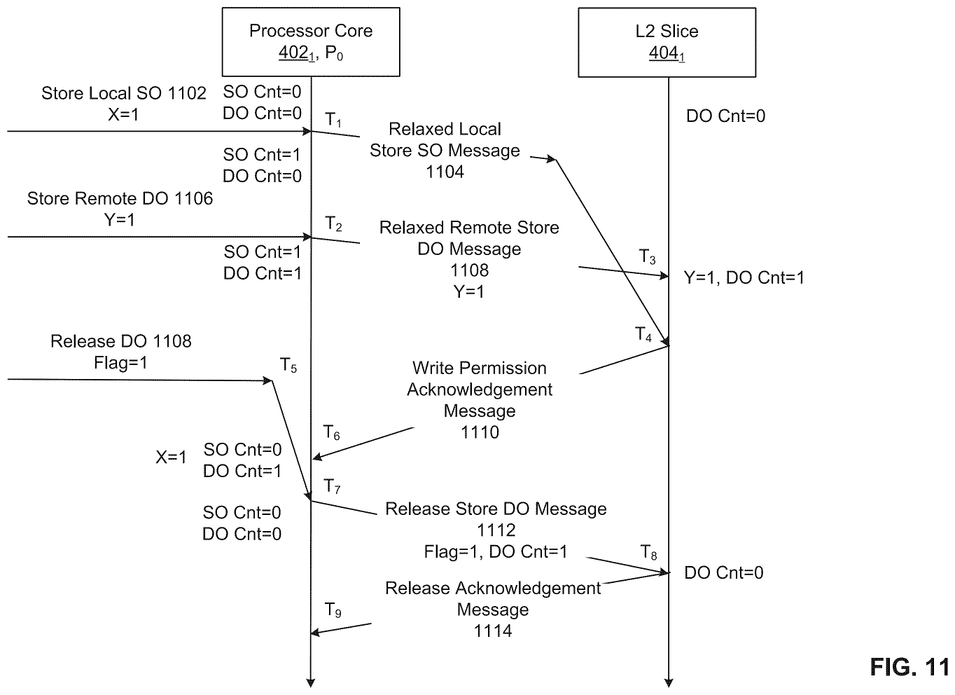

FIG. 5 is a more detailed illustration of one of the processor cores of CPU 102 of FIG. 4, according to various embodiments. As shown, processor core 402₁ includes, without limitation, source data structures 502. To facilitate directory ordering, source data structures 502 include, without limitation, a current epoch number 504, store counters 506 for each directory in a current epoch, and last unacknowledged epoch numbers 508 for each directory. Furthermore, source data structures 502 include a source ordering outstanding request acknowledgment tracker 504. Source ordering outstanding request acknowledgment tracker 504 can include, e.g., a counter or look-up table to track the completion of source ordered accesses described herein. In some embodiments, the number of all outstanding source ordered stores are tracked by a single source order counter in source ordering outstanding request acknowledgment tracker 504, and another source order counter in source ordering outstanding request tracker 510 tracks the number of outstanding loads, as discussed in greater detail below in conjunction with FIG. 11. The other processor cores 402 can include similar source data structures.

In some embodiments, store counters 506 and last unacknowledged epoch number 508 can be implemented as look-up tables. In some embodiments, epoch number 504 can be implemented as a single counter.

In operation, to perform destination ordered accesses only, processor core 402₁ can be a source component that transmits data to one or more destination components, such as an L2 slice 404 in L2 cache 340 of parallel processing subsystem 112. In some embodiments, data can be transmitted using relaxed and release store operations, according to the release consistency memory model. Relaxed store operations are store (write) operations where the ordering of the writes are not strictly enforced. A release store operation is a synchronization operation that enforces consistency by ensuring that all previous store operations within an epoch are completed before the store is made visible.

In operation, to perform source ordered accesses only (e.g., write allocate, where a processor fetches a cache line into its local L1 cache), processor core 402₁ tracks completion of pending stores in a first source access tracker. In addition, the processor tracks pending loads in a second tracker. Every source ordered access resulting in a memory request increments a specific tracker, and the tracker is decremented upon completion. The trackers can be implemented in source ordering outstanding request acknowledgment tracker 504, described above. Depending on the required memory orderings, a release that is only ordered with preceding stores can be performed when the store source acknowledgement tracker is 0. A release that shall be ordered with preceding store and loads must wait until both trackers have become 0.

In hybrid operations where processor core 402₁ issues both source and directory ordered accesses, processor core 402₁ can only send the release store to the directory after the dependent source acknowledgement tracker(s) have become 0. The release operation is a two-step process. (See appendix example flow)

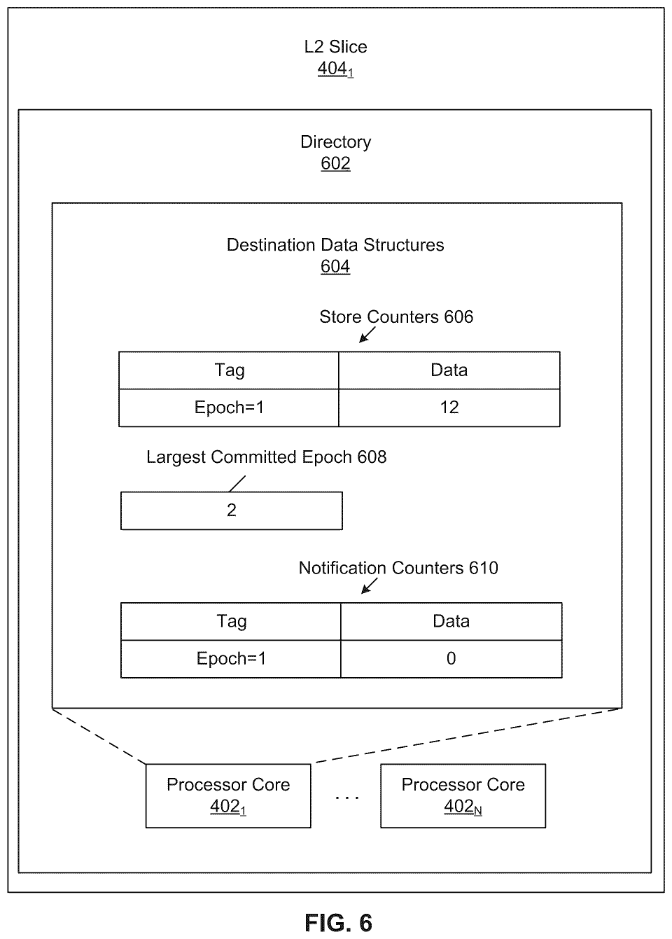

Epochs, which are tracked using current epoch number 504, divide logical time into periods between release stores. In some embodiments, epochs are initialized to a number that cannot occur, such as NULL or −1, and epoch numbers are incremented from a lowest value (e.g., 0) to a maximum value, after which the epoch numbers wrap back around to the lowest value. An epoch number of NULL (or −1 or other number that cannot occur) indicates that no preceding epoch is unacknowledged. During each epoch, processor core 402₁ can transmit, to the directory in each of the L2 cache slices 404 (or the directory in a subset of L2 cache slices) multiple relaxed store messages and a single release store message. Each relaxed remote store processor instruction makes a relaxed store request message and includes data to write and the current epoch number. The release store processor instruction makes a release store request message and includes data to write, the current epoch number, and a count of the number of relaxed stores that need to be committed by the directory, which is tracked by the directory using a store counter as discussed below in conjunction with FIG. 6, before the release store is committed. Although described herein primarily with respect to a single release store message as a reference example, some architectures may not have a release instruction, and a release can be implemented as a membar message and a dependent store message. In some embodiments, committing a relaxed stores includes performing a relaxed store operation by writing data from the relaxed store messages to a cache (e.g., an L2 cache slice 404) associated with the directory. In some embodiments, committing a release store includes performing a release store operation by writing data from the release store message to the cache associated with the directory. If the store counter of the directory indicates that fewer than the count number of relaxed store messages have been committed, then some relaxed store messages may still be in flight, and the directory will stall the release store message and retry later, such as after a predefined period of time or when the directory store counter is updated. Inclusion of the epoch number in relax and release store messages permits messages from multiple epochs to be transmitted while maintaining consistency, without having to wait for an acknowledgement that the release store for one epoch is completed before transmitting relax and release store messages for a next epoch. Because only the epoch number is embedded in the majority of the traffic (i.e., relaxed stores), directory ordering can use low-bit width representations to reduce traffic overheads. For example, in some embodiments, epoch numbers can be represented using 8 bits, which can entirely fit in some transaction packet reserved bits, incurring no traffic overheads for relaxed stores.

Store counters 506 in source data structures 502 of processor core 402₁ track the number of relaxed store messages that have been transmitted (i.e., sequence numbers) to each directory, such as directories in different L2 cache slices 404, during the current epoch. Store counters 506 can be reset at every new epoch. When a release store message is transmitted to one of the directories, the corresponding store counter 506 value is included in the release store message as the count of the number of relaxed store messages that need to be committed by the directory before the release store is committed, as described above. In some embodiments, each directory maintains a mapping from source component (e.g., processor core) ID and epoch number to store counters (Cnt[PID, Ep]), which track the number of relaxed stores committed at the directory for a specific source component-epoch pair, as discussed in greater detail below in conjunction with FIG. 6.

Because several data structures are maintained by processor core 402₁ per epoch, storage for acknowledged or committed epochs can be reclaimed. In some embodiments, processor core 402₁ removes an unacknowledged epoch entry after a release store acknowledgement message is received from a corresponding directory for the epoch. In addition, in some embodiments, when processor core 402₁ is about to overflow epoch number 504, processor core 402₁ can switch to source ordering, converting all directory ordering instructions to their source ordering equivalent. That is, instead of a Relaxed Remote Store directory ordering (DO) message, a Relaxed Remote Store source ordering (SO) SO message is sent to the directory. Alternatively, the processor can stall until an unacknowledged epoch has been acknowledged.

Continuing with the case of directory ordering only, to enable scalable release consistency semantics for multiple directories, such as directories in different L2 cache slices 404, some embodiments implement an inter-directory notification mechanism in which the directories directly notify each other to signal the completion of certain stores, thereby enforcing cross directory ordering without involving processor core 402₁. In such cases, when issuing a release store to one of the multiple directories (also referred to herein as the “destination directory” of the release store message), processor core 402₁ also embeds, in addition to the epoch number, store counter, and the last prior unacknowledged epoch number (as described above), a notification counter that indicates the number of other directories (also referred to herein as “pending directories”) that either have one or more pending relaxed store(s) in the current epoch or have one or more unacknowledged release store(s). In some embodiments, an embedding, such as embedding the epoch number, store counter, last prior unacknowledged epoch number, and notification counter, can be performed by including a corresponding data in a payload of a message (e.g., a release store message). The notification counter indicates to the destination directory that the current release store should not be committed before notifications from all pending directories are received. Concurrent with transmitting the release store message, processor core 402₁ transmits a request for notification message to each pending directory. The request for notification message includes (i) the number of relaxed stores in the current epoch for the pending directory, (ii) the last unacknowledged epoch for the pending directory, (iii) the current epoch number, and (iv) the destination directory of the current release store. Intuitively, the request for notification message informs the pending directory about all pending relaxed/release stores up to the current epoch and requests that the pending directory notify the destination directory after the pending directory commits all pending stores. After receiving such a request for notification, the pending directory will transmit a notification to the destination directory after the pending directory commits all the pending stores as embedded. Then, the destination directory can commit the release store for the epoch only after the collected number of such notifications from pending directories for processor core 402₁ equals the expected notification count embedded in the release store message, thereby ensuring that a release store for the epoch will not be committed until all prior stores at other directories have been committed, which ensures release consistency.

With the inter-directory notification described above, processor core 402₁ does not stall, as processor core 402₁ does not wait for any acknowledgments. The release store message takes at most two interconnect hops to reach all directories—one hop for the request for notification to be received by all pending directories and one hop for the actual notification message from the pending directories. As such, directory ordering results in lower processor stall time and store latency compared to source ordering. In the worst case, directory ordering generates 2n−1 control messages, i.e., when all directories are pending directories, requiring n−1 requests for notification, n−1 notifications, and 1 acknowledgment. While such messages can potentially exceed the number of messages in source ordering (depending on the workload), experience has shown that optimized real-world multi-processing-unit applications typically restrict their communication fanout, i.e., a small number of pending directories, resulting in smaller effective n. Moreover, real-world applications employ inter-processing unit synchronization granularities of at least a few kilobytes (i.e., large m) to minimize communication overheads. As such, the traffic overhead of inter-directory notifications is smaller than source ordering for most real-world applications.

In some embodiments, a source component, such as the processor core 402₁, can perform operations according to the pseudo-code of Algorithm 1:

Algorithm 1: Directory-ordering protocol at processor.

| | |
|---|---|
| 1: | procedure On Relaxed store |
| 2: | Embed epoch number to Relaxed store |
| 3: | Increment store counter |
| 4: | Send Relaxed store to its destination directory |
| 5: | procedure On Release store |
| 6: | Wait for all consistency requirement relevant outstanding source ordered requests to |

complete (510)

| | |
|---|---|
| 7: | {Prepare Release Request Message |
| 8: | Embed epoch (504) and store counter of destination directory (506) to Release |

store

| | |
|---|---|
| 9: | Embed if destination directory has entry in last unacknowledged epoch (508) of |

destination directory to Release store

| | |
|---|---|
| 10: | Track the current epoch for destination directory in unacknowledged epochs |

(508) as unacknowledged.

| | |
|---|---|
| 11: | for all pending directories do { |
| 12: | Prepare Request for Notification |
| 13: | Embed epoch (504) and store counter of pending directory (506) |
| 14: | Embed (if exists in unacknowledged epochs 508) last unacknowledged |

epoch of pending directory

| | |
|---|---|
| 15: | Send Request for Notification to the pending directory |
| | } |
| 16: | Embed pending directory count to Release Store Request Message |
| 17: | Increment epoch counter (504) and reset store counter (506) |
| 18: | Send Release store Request Message to its destination directory |

}

| | |
|---|---|
| 19: | procedure On Release store Ack |
| 20: | Mark epoch acknowledged |

Although described herein primarily with respect to release stores as a reference example, in some embodiments, a store-less barrier can include information about a current epoch and expected counter value. In such cases, the store-less barrier can return to a source that an entire set of stores has completed.

FIG. 6 is a more detailed illustration of one of the L2 slices of the L2 cache of FIG. 4, according to various embodiments. As shown, L2 slice 404₁ includes, without limitation, a directory 602 that tracks the coherence state and location of cache lines to manage access and maintain consistency across multiple caches. Directory 602 of L2 slice 404₁ includes, without limitation, destination data structures 604. For each processor core 402, destination data structures 604 store a counter for processor core 402 and each epoch associated with processor core 402, a largest committed epoch for the processor core 402, and a notification counter for the processor core 402 and each epoch associated with the processor core 402. Illustratively, for processor core 402₁, destination data structures 604 include, without limitation, store counters 606, a largest committed epoch 608, and notification counters 610. In some embodiments, each of destination data structures 604 can be implemented on a per-processor core 402 basis with statically partitioned storage to handle look-up table overflow under worst-case scenarios. The other L2 slices 404 can include similar directories and destination data structures.

In operation, directory 602 can receive relaxed store messages and release messages from one or more source components, such as processor cores 402. As described, each relaxed store message from a source component includes data to write and an epoch number. Upon receiving a relaxed store message, directory 602 commits the relaxed store to the L2 cache, shown as L2 slice 404₁, by storing the data in the relaxed store message in the L2 cache. That is, relaxed stores can be immediately committed to the L2 cache. Although described herein primarily with respect to L2 caches as a reference example, in some embodiments, directory ordering can be enforced at arbitrary cache levels in a cache hierarchy. To support arbitrary cache levels, an instruction set architecture can support scope hints (e.g., release at L2, release at L3). In the absence of scopes, the enforcement can be at the last-level cache, which is L2 in the examples herein. Illustratively, directory 602 also increments a store counter associated with the source component that transmitted a relaxed store message and the epoch embedded in the relaxed store message. For example, directory 602 could increment store counter 606 for epoch 1 and processor core 402₁ from 12 to 13 if directory 602 receives a relaxed store message with epoch 1 embedded from processor core 402₁.

As described, each release store message from a source component includes data to write, an epoch number, (optionally) the last unacknowledged epoch number, a count of the number of relaxed store messages that need to be committed by directory 602 before the release store is committed, and (optionally) a number of notifications from pending directories that need to be received. Upon receiving a release store message, directory 602 commits the release store if and only if (i) the embedded store counter in the release store message matches the store counter for the same source component and epoch number that is maintained by directory 602, (ii) the last unacknowledged epoch for the source component that is embedded in the release store message has been committed, and (iii) all inter-directory notifications have been collected. For example, if directory 602 received, from processor core 402₁, a release store message that includes an embedded epoch of 1, store counter of 12, unacknowledged epoch number of NULL, and notification count of 1, then directory 602 would not commit the release store because, although store counter of 12 matches store counter 606 for epoch 1, notification counters 610 indicate that 0, rather than 1, notification has been received from pending directories. Note that a last unacknowledged epoch of NULL represents an epoch that has been committed before the current release operation was issued. Therefore, if an unacknowledged epoch of NULL is received, it does not need to be compared against the directory's largest committed epoch number. That is, a last unacknowledged epoch of NULL means that all preceding epochs are already committed. As another example, if directory 602 received, from processor core 402₁, a release store message that includes an embedded epoch of 1, store counter of 12, unacknowledged epoch number of NULL, and notification count of 0, then directory 602 would commit the release store.

In addition, when directory 602 receives a request for notification from a source component, the request for notification triggers a notification to be sent to a destination directory indicated in the request for notification when all relaxed and release stores are committed at directory 602 and if the unacknowledged epoch number is NULL or equals the directory epoch number.

Directory 602 removes a corresponding store counter 606 and notification counter 610 entry after an epoch is committed, and directory 602 also removes the store counter 606 entry after a notification is sent for an epoch. Doing so ensures that the storage for directory-ordering does not accumulate indefinitely.

In some embodiments, a destination component, such as directory 602, can perform operations for directory ordering according to the pseudo-code of Algorithm 2:

Algorithm 2: Directory-ordering protocol at directory.

| | |
|---|---|
| 18: | procedure On Relaxed store message |
| 19: | Commit Relaxed store to LLC |
| 20: | Increment store counter (606) for the epoch embedded in the relaxed store |

message

| | |
|---|---|
| 21: | procedure On Release store message |
| 22: | if embedded store counter matches the directory (606) store counter for the |

epoch embedded in the release store

and last unAck-ed epoch committed is either NULL or matches directory's largest

committed epoch (608)

and count of inter-directory notifications received tracked in notification counter

(610) matches the expected notification count embedded in the release store message
then

| | |
|---|---|
| 23: | Commit Release store to LLC |
| 24: | else Retry later |
| 25: | procedure On Request for Notification |
| 26: | if embedded store counter matches the directory's (606) for the epoch |

embedded in the release store

and last unAck-ed epoch committed then is either NULL or matches directory's

larges committed epoch (608)

| | |
|---|---|
| 27: | Send notification to the destination directory |
| 28: | else Retry later |
| 29: | procedure On Notification |
| 30: | Increment notification count (610) for epoch embedded in notification message |

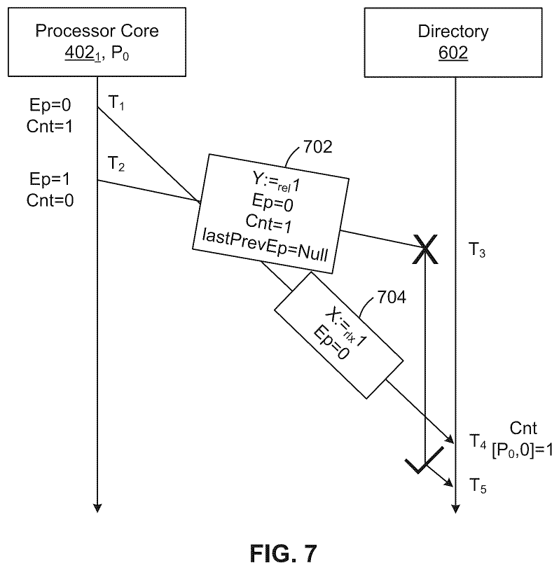

FIG. 7 illustrates how directory ordering enforces an ordering between a relaxed store and a subsequent release store hosted by the same directory, according to various embodiments. As shown, at time T₁, processor core 402₁, denoted by P₀, transmits a relaxed store message 704 with an embedded epoch 0. At time T₂, processor core 402₁ transmits a release store message 702 with an embedded epoch 0, store counter 1, and last unacknowledged epoch of NULL. As described, in some embodiments, a source component, such as processor core 402₁, embeds only the epoch number in each relaxed store request while embedding the epoch number, store counter, and last unacknowledged epoch, in each release store request.

Illustratively, relaxed store message 704 arrives at directory 602 at time T₄, which is after the arrival time T₃ of release store message 702. When relaxed store message 704 arrives at directory 602, directory 602 immediately commits the relaxed store and increments the store counter in the directory for the corresponding processor-epoch pair. By contrast, when release store message 702 arrives at directory 602, directory 602 can only commit the release store if the embedded store counter of 1 matches the store counter (e.g., one of store counters 606) that directory 602 maintains for the corresponding processor and epoch. Otherwise, the release store is stalled, as shown by directory 602 waiting from time T₃ to time T₅, after relaxed store message 704 is received and the store counter in the directory is incremented to 1 (Cnt[P₀,0]=1), matching the store counter of 1 (Cnt=1) embedded in release store message 702. Stalling the release store ensures that a relaxed store (e.g., relaxed store message 704) is always committed before a subsequent release store (e.g., release store message 702) if the same directory handles both.

Although described herein primarily with respect to a release store waiting at the destination directory until the store counter reaches the embedded store counter in the release store, in some embodiments, the release store can be re-tried, or a separate virtual channel can be used for release stores. The re-trying of release stores or separate virtual channel can avoid deadlocks caused if a waiting release store head-of-line blocks other stores.

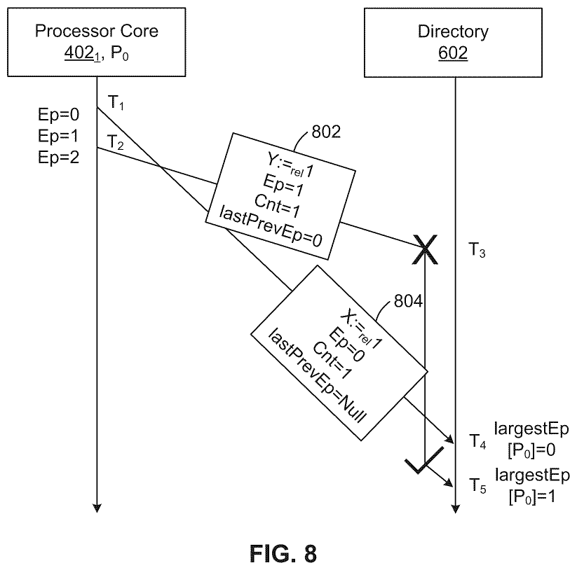

FIG. 8 illustrates how directory ordering enforces an ordering between two release stores at the same directory, according to various embodiments. As shown, at time T₁, processor core 402₁, denoted by P₀, transmits a release store message 804 with an embedded epoch 0, store counter 1, and last unacknowledged epoch of NULL. The last unacknowledged epoch is an epoch number for which a corresponding release store has been issued to directory 602 by processor core 402₁ but has not been acknowledged. If no entry for an unacknowledged epoch for the destination directory exists in the processor core's 402₁ unacknowledged epoch numbers 508 data structure (i.e., there are no outstanding preceding releases), processor core 402₁ transmits a reserved value, namely lastPrevEp=NULL in this example, signaling to the directory that any conditional checks involving this value are to be considered true. It should be noted that directory ordering still requires release stores to be acknowledged. Processor core 402₁ tracks the unacknowledged epochs using unacknowledged epoch numbers 508 data structure, described above in conjunction with FIG. 5. At time T₂, processor core 402₁ transmits a release store message 802 with an embedded epoch 1, store counter 1, and last unacknowledged epoch of 0.

Directory 602 tracks, for each source component (e.g., each processor core 402), the largest committed epoch (largestEp[PID]), such as largest committed epoch 608 for processor core 402₁ that is described above in conjunction with FIG. 6. Directory 602 can commit a release store only if an embedded unacknowledged last epoch, such as the embedded last unacknowledged epoch of 0 (lastPrevEp=0 in release store message 802) has been committed. Otherwise, the release store is stalled so as to ensure that release stores are committed following their program order. Illustratively, even assuming that the 1 relaxed store for epoch 1, indicated by the embedded store counter (Cnt=1) in release store message 802, has been received, directory 602 does not commit the release store when release store message 802 is received at time T₁ because the embedded last unacknowledged epoch of 0 (lastPrevEp=0) in release store message 802 has not yet been committed. Only after release store message 804 for epoch 0 is received and committed at time T₄ and the largest committed epoch is incremented to 0 (largestEp[PID]=0), matching the last epoch of 0 in release store message 802, is release store message 802 committed at time T₅.

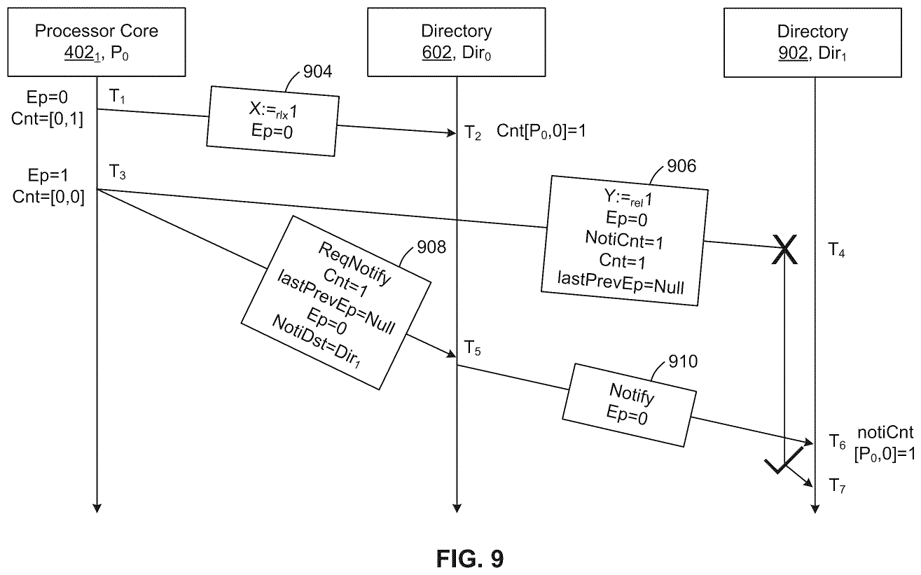

FIG. 9 illustrates how inter-directory notification enables release-consistent ordering between a relaxed store and a subsequent release store at two different directories, according to various embodiments. As shown, processor core 402₁, denoted by P₀, transmits a relaxed store message 904 with an embedded epoch of 0 at time T₁, and relaxed store message 904 arrives and is committed by directory 602, denoted by Dir₀, at time T₂. Then, at time T₃, processor core 402₁ transmits, to another directory 902, a release store that includes an embedded epoch of 0, a notification counter of 1, a store counter of 1, and a last unacknowledged epoch of NULL. In some embodiments, when issuing a release store to a destination directory, in addition to the epoch number, store counter, and the last unacknowledged epoch number (as described above), a source component can also embed a notification counter (NotiCnt), which tracks the number of other directories (i.e., pending directories) that either has one or more pending relaxed store(s) in the current epoch or has one or more unacknowledged release store(s). The notification counter in release store message 906 indicates to destination directory 902 that the current release store should not be committed before notifications from all pending directories are received.

Concurrent with transmission of release store message 906, processor core 402₁ transmits, at time T₃, a “request for notification” message 908 to each pending directory, shown as directory 602. The request for notification message 908 includes (1) the number of relaxed stores in the current epoch for the target pending directory (Cnt=1 in request for notification message 908), (2) the last unacknowledged epoch for the target pending directory (lastPrevEp=NULL in request for notification message 908, as in this example it is assumed that no preceding releases are unacknowledged for Dir₀ at the processor core 402₁), (3) the current epoch number (Ep=0 in request for notification message 908), and (4) the destination directory of the current release store (NotiDst=Diri in request for notification message 908)). Intuitively, request for notification message 908 informs the target pending directory 602 about all pending relaxed/release stores up to the current epoch and requests directory 602 to notify destination directory 902 after directory 602 commits all pending stores.

Upon receiving a request for notification, a pending directory sends a notification to the destination directory after the pending directory commits all the pending stores as embedded. The destination directory can commit a release store only after the destination directory has collected a number of notifications for the corresponding source component and epoch number (notiCnt[PID, Ep]) that equals the notification counter embedded in the release store message. Doing so ensures that a release store will not be committed until all prior stores at other directories have been committed, ensuring release consistency. Illustratively, release store message 906 is not committed when directory 902 receives release store message 906 at time T₄. Instead, directory 902 waits until after notification 910 is received at time T₆ and the notification counter for the source component and epoch is incremented to 1 ([P₀, 0]=1), matching the notification counter of 1 in release store message 906, to commit the release store at time T₇.

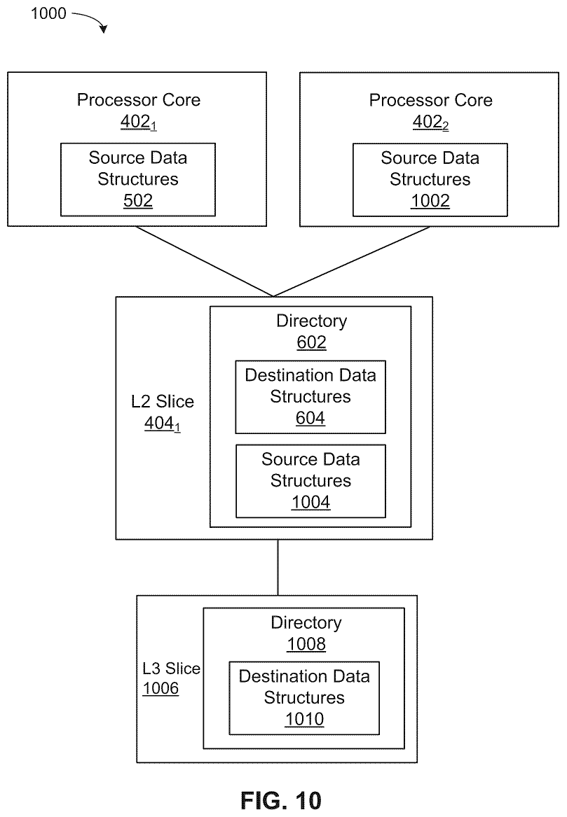

FIG. 10 illustrates an exemplar hierarchy of source and destination components that implements directory-ordered release consistency, according to various embodiments. As shown, a hierarchy 1000 includes, without limitation, processor cores 402₁ and 402₂, directory 602 in L2 slice 404₁, and a directory 1008 in an L3 slice 1006 of an L3 cache (e.g., L3 cache 213). L3 slice 1006 can be in the same processor as L2 slice 404₁ or in another processor in some embodiments. In hierarchy 1000, each of the processor cores 402₁ and 402₂ is a source component that includes source data structures 502 and 1002, respectively. Directory 602 is a destination component to processor cores 402₁ and 402₂ and a source component to directory 1008. Directory 602 includes destination data structures 604 and source data structures 1004, which can be similar to source data structures 502. Directory 1008 is a destination component to directory 602. Directory 1008 includes destination data structures 1010, which can be similar to destination data structures 604. In operation, each source component (e.g., processor core 402₁, processor core 402₂, or L2 slice 404₁) can transmit relaxed and release store messages for processing by corresponding director(ies) (e.g., directory 602 or 1008) as described above in conjunction with FIGS. 4-9.

Although hierarchy 1000 is shown for illustrative purposes, in some embodiments, any technically feasible source and destination components, at any level of granularity, can be included in a hierarchy of source and destination components that implements directory-ordered release consistency. As described, in some embodiments, source and destination components can be at any level of granularity, such as a source at a thread granularity, a processor granularity, a cluster of processors granularity, and/or a system node granularity, etc. and a destination that is a memory at some granularity (e.g., L2 slice, L2 cache, multiple remote L2 caches, next level memory in hierarchy L3, etc.).

Further, in some embodiments, in hierarchy 1000, a directory ordered release can complete at any level in the hierarchy. The hierarchy level can be specified by annotating the release instruction executed by the processor core with a scope (e.g., release.L2 or release.L3).

FIG. 11 illustrates how combined source-ordered and directory-ordered release consistency can be implemented, according to various embodiments. As shown, source and directory ordered accesses from processor core 402₁ to L2 slice 404₁ include accesses via a relaxed local store source ordered (SO) message 1104, a relaxed remote directory ordered (DO) message 1108, a write permission acknowledgement message 1110, a release store DO message 1112, and a release acknowledgement message 1114. This example assumes a single source ordering counter for simplicity and does not distinguish between potential load and store instructions.

In some embodiments, leveraging heuristics leveraging heuristics, a processor may switch at any time between source and directory ordering without breaking coherence and violating memory consistency and henceforth correctness. In particular, different instructions can be implemented in the processor to expose different behaviors to a programmer, such as store-remote-non-posted (for non-posted write, a processor receives acknowledgment to processor source ordering) or store-remote-posted (no acknowledgment sent to a processor because of destination ordering). For source ordering, a processor can perform a store instruction corresponding to Store Remote Source Ordered, with the instruction being implemented either as a unique instruction (e.g. stremoteso) or a common store instruction with a hint (Store Remote Source Ordered). The data is written to a cache (e.g., a low-level cache), and a cache line is allocated in the cache. The number of all outstanding source ordered stores are tracked by a single source order counter (e.g., in source ordering outstanding request tracker 510). Another source order counter (e.g., in source ordering outstanding request tracker 510) can track the number of outstanding loads. Source order counters exist only once and are not replicated for multiple epochs, because all source ordered requests must complete before the processor can advance to a new epoch. The processor can also perform a store instruction corresponding to Store Local Source Ordered. In such cases, the instruction can be either implemented as a unique instruction (e.g., stlocalso) or a common store instruction with a hint (Store Local Source Ordered). Write permission (in some cases also the most recent copy of a cache line) is requested for the cache line by an L1 cache in the processor. Once granted permission, the L1 cache can allocate the cache line in one of its entries and the data is updated. For directory ordering, the processor can perform a store instruction corresponding to Store Remote Directory Ordered, and the instruction can be either implemented as a unique instruction (e.g. stremotedo) or a common store instruction with a hint (Store Through Destination Ordered).

Illustratively, at time T₁, processor core 402₁ serves Store Local SO instruction 1102, sending a Relaxed Local Store SO message 1104 to L2 slice 404₁ and incrementing a local SO counter, shown as SO Cnt=1. The current epoch has been omitted for simplicity.

At time T₂, processor core 402₁ serves a Store Remote DO instruction 1106, sending a Relaxed Remote Store DO message 1008 to L2 slice 404₁ and incrementing a local DO counter, shown as DO Cnt=1. The current epoch and DO Cnt for multiple directories are omitted for simplicity.

At time T₃, L2 slice 404₁ receives the Relaxed Remote Store DO message 1108 and performs the write of Y=1 and increments a local DO counter, shown as DO Cnt=1. Again, the current epoch and source processor ID have been omitted for simplicity.

At time T₅, processor core 402₁ stalls serving a Release DO instruction 1108. This is the case, because processor core 402₁ cannot issue a Release Store DO message until the local SO counter has become 0. Processor core 402₁ waits for a Write Permission Acknowledgment Message, which is transmitted by L2 slice 404₁ at time T₄ and arrives at time T₆. Once the Write Permission Acknowledgement message is received, processor core 402₁ can complete the store of X=1 and decrement the SO Cnt., shown as SO Cnt=0. The Store of X must become visible in memory before the release of FLAG=1 can be performed. When the SO Cnt is 0, all outstanding memory accesses (load/store) preceding the release have completed, which is necessary to correctly enforce release consistency. Therefore, the processor core 402₁ can now send the Release Store DO message to the remote directory, shown as Release Store DO message 1112 being sent at time T₇ and received at time T₈.

At time T₈, if the Release Store DO message 1112 DO Cnt and the L2 slice 404₁ DO Cnt are equal, L2 slice 404₁ writes Flag=1 to the corresponding cache line, acknowledges the completion of the release (shown as release acknowledgement message 1114) to processor core 402₁, and resets its local DO Cnt (for the corresponding epoch) to 0, shown as DO Cnt=0. At time T₉, once processor core 402₁ observes the Release Acknowledgement message 1114, processor core 402₁ can reclaim the corresponding epoch for future instructions.

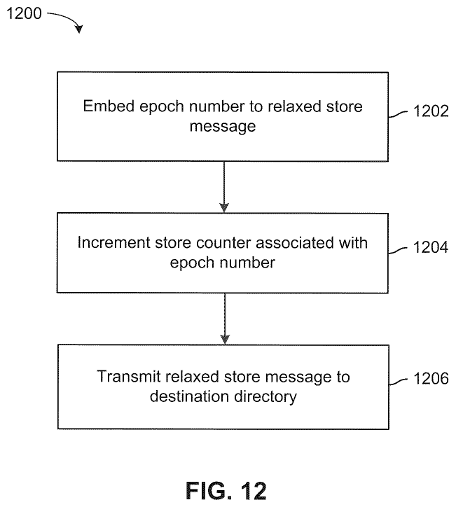

FIG. 12 is a flow diagram of method steps for transmitting a relaxed store message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1200 begins at step 1202, where a source component embeds an epoch number in a relaxed store message. As described, the source component can be at any level of granularity in some embodiments. For example, the source component could be a processor core or stream multiprocessor executing a thread, a processor, a cluster of processors, a system node, etc. In some embodiments, the source component generates the relaxed store message to include the epoch number in a payload of the relaxed store message, thereby embedding the epoch number in the relaxed store message.

At step 1204, the source component increments a store counter associated with the epoch number. As described, store counters (e.g., store counters 506) in the source data structures of a source component track the number of relaxed store messages that have been transmitted (i.e., sequence numbers) to each destination component, such as directories in different L2 cache slices, during the current epoch.

At step 1206, the source component transmits the relaxed store message to a destination directory. As described, the destination directory is a destination component that can be memory at any level of granularity (e.g., an L2 slice, L2 cache, multiple remote L2 caches, next level memory in hierarchy L3).

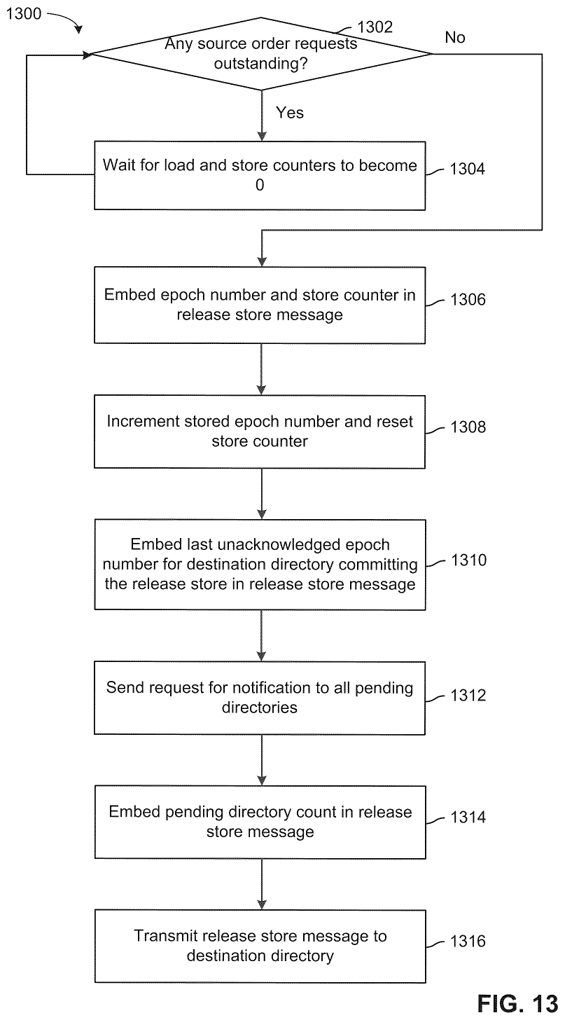

FIG. 13 is a flow diagram of method steps for transmitting a directory ordered release store message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1300 begins at step 1302, where if there are any source order requests (load/store non-posted) outstanding, then method 1300 continues to 1304, where a source component (e.g., processor core 402₁) waits for load and store counters (e.g., in source ordering outstanding acknowledgement request tracker 510 when the source component is processor core 402₁) to become 0, after which method 1300 returns to step 1302. That is, the source component performs a source ordering completion check prior to issuing a release, which is required for correctness, as described above in conjunction with FIG. 11.

On the other hand, if there are no source order requests outstanding, then at step 1306, the source component embeds an epoch number and a store counter in a release store message. As described, in some embodiments, the source component can be at any level of granularity, such as a processor core or stream multiprocessor that executes a thread, a processor, a cluster of processors, a system node, etc. In some embodiments, the source component generates the release store message to include the epoch number and the store counter in a payload of the release store message, thereby embedding the epoch number and the store counter in the release store message. In some embodiments, the embedded epoch number and store counter can be obtained from source data structures (e.g., source data structures 502) that store the epoch number and store counters that track the number of relaxed store messages that have been transmitted to each directory (e.g., store counters 506).

At step 1308, the source component increments a stored epoch number and resets a store counter. The epoch number and the store counter can be included in the source data structures (e.g., source data structures 502), described above. In some embodiments, epochs are initialized to a number that cannot occur, such as NULL or −1, and epoch numbers are incremented from a lowest value (e.g., 0) to a maximum value, after which the epoch numbers wrap back around to the lowest value. In some embodiments, when there are multiple store counters for different directories, the multiple store counters can be reset at step 1308.

At step 1310, the source component embeds a last unacknowledged epoch number for the destination directory committing the release store in the release store message. The last unacknowledged epoch number is an epoch number for which the source component has not received a release store acknowledgement message from a destination component indicating a release store for the epoch was committed. In some embodiments, the last unacknowledged epoch number can be stored in the source data structures (e.g., source data structures 502), described above. In some embodiments, the source component adds the last unacknowledged epoch number to a payload of the release store message, thereby embedding the last unacknowledged epoch number in the release store message.

At step 1312, the source component sends a request for notification to all pending directories. Each pending directory is a directory that either has one or more pending relaxed store(s) in the current epoch or has one or more unacknowledged release store(s). In some embodiments, the request for notification to a pending directory is a message that includes (i) the number of relaxed stores in the current epoch for the pending directory, (ii) the last unacknowledged epoch for the pending directory, (iii) the current epoch number, and (iv) the destination directory of the current release store. After receiving such a request for notification, the pending directory will transmit a notification to the destination directory after the pending directory commits all the pending stores as embedded. Then, the destination directory can commit the release store only after the collected number of such notifications equals the expected notification count embedded in the release store message, the number of committed relaxed stores equals the expected store count embedded in the release store message, and either the largest epoch equals the last unacknowledged epoch embedded in the release store message or no last unacknowledged epoch existed at the directory, as denoted by the value NULL in the release store message. Thereby, the directory can ensure that a release store will not be committed until all prior stores at other directories have been committed, which ensures release consistency.

At step 1314, the source component embeds a pending directory count in the release store message. The pending directory count indicates a number of pending directories that need to notify a destination directory before the destination directory can commit a release store. In some embodiments, the source component adds the pending directory count to a payload of the release store message, thereby embedding the pending directory count in the release store message.

At step 1316, the source component transmits the release store message to a destination directory. As described, the destination directory is a destination component that can be at any level of granularity (e.g., an L2 slice, L2 cache, multiple remote L2 caches, next level memory in hierarchy L3)

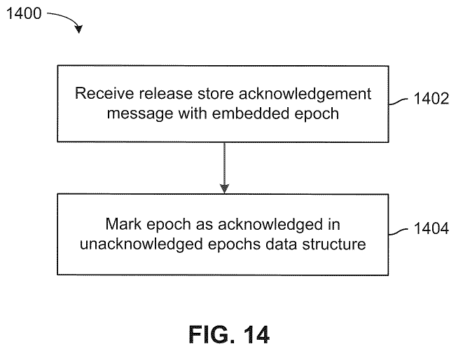

FIG. 14 is a flow diagram of method steps for processing a release store acknowledgement message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1400 begins at step 1402, where a source component receives a release store acknowledgement message with an embedded epoch. As described, in some embodiments, the source component can be at any level of granularity, such as a processor core or stream multiprocessor that executes a thread, a processor, a cluster of processors, a system node, etc. In some embodiments, the release store acknowledgement message is transmitted by a destination component to indicate a release store for an epoch has been committed.

At step 1404, the source component marks the epoch as acknowledged in an unacknowledged epochs data structure (e.g., unacknowledged epochs data structure 502 when the source component is the processor core 402₁). As described, in some embodiments, the unacknowledged epoch data structure is included in the source data structures of the source component and can be implemented as, for example, a look-up table.

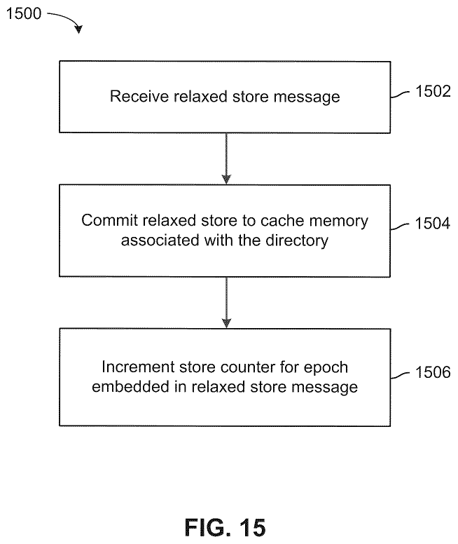

FIG. 15 is a flow diagram of method steps for processing a relaxed store message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1500 begins at step 1502, where a directory (e.g., directory 602) receives a relaxed store message. As described, the directory is a destination component that can be memory at any level of granularity (e.g., an L2 slice, L2 cache, multiple remote L2 caches, next level memory in hierarchy L3). In some embodiments, the relaxed store message can include data to write and an embedded epoch number.

At step 1504, the directory commits the relaxed store to cache memory associated with the directory. In some embodiments, committing the relaxed store includes performing a relaxed store operation by writing data from the relaxed store message to the cache memory associated with the directory.

At step 1506, the directory increments a store counter for an epoch embedded in the relaxed store message. In some embodiments, the directory increments a store counter associated with the source component that transmitted the relaxed store message and the epoch embedded in the relaxed store message.

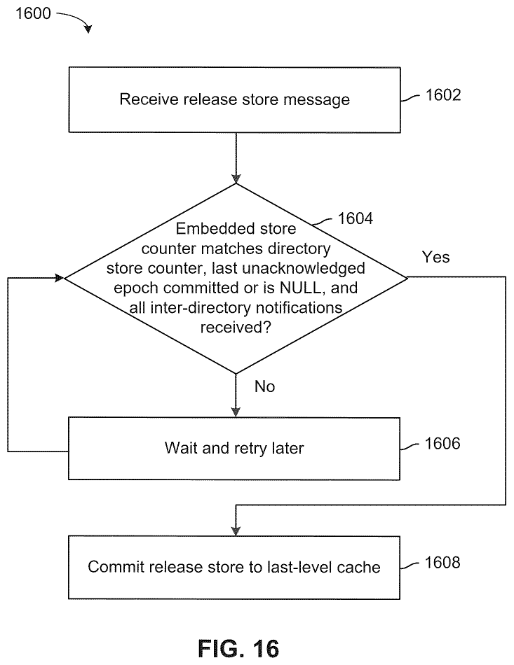

FIG. 16 is a flow diagram of method steps for processing a release store message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1600 begins at step 1602, where a directory (e.g., directory 602) in a destination component receives a release store message. As described, the directory is a destination component that can be memory at any level of granularity (e.g., an L2 slice, L2 cache, multiple remote L2 caches, next level memory in hierarchy L3). In some embodiments, the release store message can make a release store request and include data to write, the current epoch number, and a count of the number of relaxed stores that need to be committed by the directory, which is tracked by the directory using a store counter, before the release store is committed.

At step 1604, the directory determines whether a store counter embedded in the release store message matches a directory store counter, a last unacknowledged epoch in the release store message has been committed, and all inter-directory notifications associated with the release store message have been received. As described, in some embodiments, each release store message from a source component includes data to write, an epoch number, a last unacknowledged epoch number, a count of the number of relaxed store messages that need to be committed by the directory before the release store is committed, and (optionally) a number of notifications from pending directories that need to be received. Upon receiving such a release store message, the directory commits the release store if and only if (i) the embedded store counter in the release store message matches the store counter for the same source component and epoch number that is maintained by the directory, (ii) the last unacknowledged epoch for the source component that is embedded in the release store message has been committed or is NULL, and (iii) all inter-directory notifications have been collected. A last unacknowledged epoch that is NULL represents an epoch that logically has been committed before the current release operation was issued.

If the directory determines the store counter embedded in the release store message does not match the directory store counter, the last unacknowledged epoch in the release store message is not NULL and has not been committed, or that not all inter-directory notifications associated with the release store message have been received, then the method 1600 continues to step 1606, where the directory waits by stalling the release store and retries again later. After waiting (e.g., for a predefined period of time) or when one of the counters for the epoch in the data structure 604 are updated, the method 1600 returns to step 1604, where the directory again determines whether the store counter embedded in the release store message matches the directory store counter, a last unacknowledged epoch in the release store message is NULL or has been committed, and all inter-directory notifications associated with the release store message have been received.

On the other hand, if the directory determines at step 1604 that the store counter embedded in the release store message matches the directory store counter, the last unacknowledged epoch in the release store message is NULL or has been committed, and that all inter-directory notifications associated with the release store message have been received, then method 1600 proceeds directly to step 1608, where the directory commits the release store to a the cache associated with the directory. In some embodiments, committing the release store includes performing a release store operation by writing data from the release store message to the associated cache after having ensured that all prior relaxed store writes are visible.

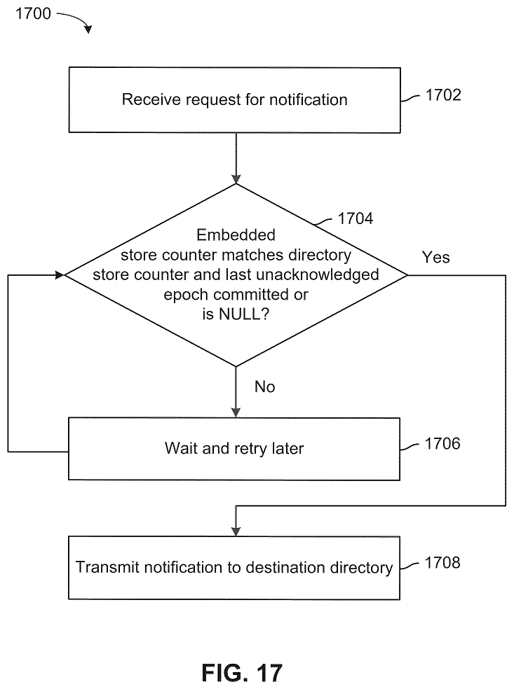

FIG. 17 is a flow diagram of method steps for processing a request for notification message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1700 begins at step 1702, where a directory receives a request for notification. As described, the directory is a destination component that can be memory at any level of granularity (e.g., an L2 slice, L2 cache, multiple remote L2 caches, next level memory in hierarchy L3).

At step 1704, the directory determines whether a store counter embedded in the request for notification matches a directory store counter and a last unacknowledged epoch embedded in the request for notification has been committed or is NULL. If the directory determines that the store counter embedded in the request for notification does not match the directory store counter or the last unacknowledged epoch embedded in the request for notification is not NULL and has not been committed, then the method 1700 continues to step 1706, where the directory waits and retries later. After waiting (e.g., for a predefined amount of time or until a counter associated with the current epoch is updated), the method 1700 returns to step 1704, where the directory again determines whether the store counter embedded in the request for notification matches the directory store counter and the last unacknowledged epoch embedded in the request for notification is NULL or has been committed.

On the other hand, if the directory determines at step 1704 that the store counter embedded in the request for notification matches the directory store counter and the last unacknowledged epoch embedded in the request for notification is NULL or has been committed, then method 1700 proceeds directly to step 1708, where the directory transmits a notification to the destination directory specified by the request for notification.

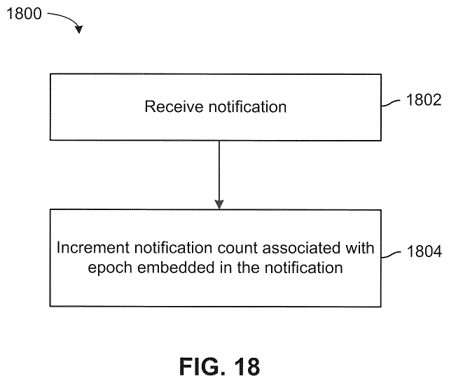

FIG. 18 is a flow diagram of method steps for processing a notification message, according to various embodiments. Although the method steps are described in conjunction with the systems of FIGS. 1-11, persons of ordinary skill in the art will understand that any system configured to perform the method steps, in any order, is within the scope of the present disclosure.

As shown, a method 1800 begins at step 1802, where a directory receives a notification from another directory. As described, the directory is a destination component that can be memory at any level of granularity (e.g., an L2 slice, L2 cache, multiple remote L2 caches, next level memory in hierarchy L3). In some embodiments, the other directory can be a pending directory that has received a request for notification and transmits the notification after a store counter embedded in the request for notification matches a store counter of the directory and the last unacknowledged epoch embedded in the request for notification is NULL or has been committed, as described above in conjunction with FIG. 16.

At step 1804, the directory increments a notification count associated with an epoch embedded in the notification. In some embodiments, the notification count can be included in destination data structures of the directory (e.g., destination data structures 604) and indicate a number of notifications from pending directories that need to be received before a release store for the epoch can be committed.

In sum, various embodiments include techniques for directory-ordered release consistency. Unlike source ordering, which orders stores at the source component (e.g., a processor or processor core) using acknowledgments to enforce release consistency, directory ordering directly orders stores at the destination component (e.g., a cache directory). In some embodiments, a source component, such as a processor core or processor, stores (1) for purposes of source ordering, a counter of outstanding source order requests, and (2) for purposes of directory ordering, source data structures that include a current epoch number, store counters for each directory in a current epoch, and last unacknowledged epoch numbers for each directory. Each destination component, such as, for example, a level 2 (L2) cache slice, includes a directory that stores, for purposes of directory ordering, a counter for each source component and each epoch associated with the source component, a largest committed epoch for each source component, and a notification counter for each source component and each epoch associated with the source component. For directory ordering, a source component can transmit data to one or more directories using relax and release store operations, according to the release consistency memory model. Epochs, which are tracked by the source component using the current epoch number, divide logical time into periods between release stores. During each epoch, the source component transmits, to each directory (or a subset of the directories), multiple relaxed store messages and a single release store message. Each relaxed store message includes (1) data to write and (2) the current epoch number. The release store message includes (1) data to write, (2) the current epoch number, (3) a last unacknowledged epoch number, and (4) a count of the number of relaxed store messages that need to be committed by the directory, which is tracked by the directory using the store counter described above, before the release store is committed. If the store counter of the directory indicates that fewer than the count number of relaxed store messages have been committed, then some relaxed store messages may still be in flight, and the directory will stall the release store message and retry later, such as after a predefined period of time or if a counter (e.g., the relaxed store counter) of the epoch is updated. When there are multiple directories, such as multiple directories in different L2 slices of an L2 cache, an inter-directory notification mechanism permits the directories to directly notify each other of the completion of certain stores, thereby enforcing cross directory ordering without involving the source component. More specifically, when issuing a release store to one of the multiple directories (also referred to herein as a “destination directory”), the source component also embeds, in addition to the epoch number, store counter, and the last prior unacknowledged epoch number (as described above), a notification counter that indicates the number of other directories (also referred to herein as “pending directories”) that either has one or more pending relaxed store(s) in the current epoch or has one or more unacknowledged release store(s). The notification counter indicates to the destination directory that the current release store should not be committed before notifications from all pending directories are received. Concurrent with transmitting the release store message, the source component transmits a request for notification message to each pending directory. The request for notification message includes (1) the number of relaxed stores in the current epoch for the pending directory, (2) the last unacknowledged epoch for the pending directory, (3) the current epoch number, and (4) the destination directory. The request for notification message requests that the pending directory notify the destination directory after the pending directory commits all pending stores. After receiving such a request for notification, the pending directory will transmit a notification to the destination directory after the pending directory commits all the pending stores as embedded and the previous epoch equals the last unacknowledged epoch. Then, the destination directory commits the release store only after the collected number of such notifications from pending directories for the source component and epoch number equals the notification counter embedded in the release store message and the destination directory's previous epoch equals the last unacknowledged epoch, thereby ensuring that a release store will not be committed until all prior stores (and releases) at other directories have been committed, which ensures release consistency.

At least one technical advantage of the disclosed techniques relative to the prior art is that the disclosed techniques use directory ordering to reduce the number of messages that are transmitted between source and destination components of a computing system in order to implement release consistency. The reduced number of messages results in lower latency relative to source ordering, improving the overall performance of the computing system. The reduced number of messages also reduces the interconnect traffic and energy consumption of the computing system. In addition, directory ordering enables scalable release consistency semantics across multiple directories, including directories in a hierarchy. Another technical advantage of disclosed techniques is that, leveraging heuristics, a processor may switch at any time between source and directory ordering without breaking coherence and violating memory consistency and henceforth correctness. In particular, different instructions can be implemented in the processor to expose different behaviors to a programmer, such as store-remote-non-posted (for non-posted write, a CPU receives acknowledgment to perform source ordering) or store-remote-posted (no acknowledgment sent to a CPU because of destination ordering). Such a mechanism extends state of the art coherence protocols that use source ordering to support directory ordering. These technical advantages provide one or more technological improvements over prior art approaches.
1. In some embodiments, a computer-implemented method for inter-processor communication comprises generating a relaxed store message that comprises a first epoch number, incrementing a first counter associated with the first epoch number, and transmitting the relaxed store message to a first directory included in a cache.
2. The computer-implemented method of clause 1, further comprising generating a release store message that comprises the first epoch number, the first counter, and a last unacknowledged epoch number, incrementing a stored epoch number, resetting the first counter, and transmitting the release store message to the first directory.
3. The computer-implemented method of clauses 1 or 2, wherein the first directory performs a release store operation based on the release store message only after (i) a second counter maintained by the first directory matches the first counter, and (ii) the last unacknowledged epoch number has been committed.
4. The computer-implemented method of any of clauses 1-3, wherein the release store message further comprises a second counter indicating a number of notifications that need to be received from one or more second directories included in the cache.
5. The computer-implemented method of any of clauses 1-4, further comprising transmitting, to each second directory included in the one or more second directories, a request to notify the first directory after the second directory commits one or more stores associated with the first epoch number.
6. The computer-implemented method of any of clauses 1-5, further comprising receiving, from the first directory, an acknowledgement message associated with the release store message, and updating a data structure to indicate that the first epoch number has been acknowledged.
7. The computer-implemented method of any of clauses 1-6, further comprising, prior to generating the release store message, determining that no source ordering requests are outstanding.
8. The computer-implemented method of any of clauses 1-7, wherein either the release store message is transmitted via a distinct virtual channel for release store messages, or the release store message re-transmitted to the first directory.
9. The computer-implemented method of any of clauses 1-8, wherein the cache comprises at least one of an L2 slice, a L2 cache, one or more remote L2 caches, an L3 cache, or a next level memory in a plurality of caches.
10. The computer-implemented method of any of clauses 1-9, wherein the plurality of caches is included in a hierarchy of caches.
11. The computer-implemented method of any of clauses 1-10, further comprising generating a store-less barrier that comprises the first epoch number and the first counter, and transmitting the store-less barrier to the first directory.
12. In some embodiments, one or more non-transitory computer-readable media store instructions that, when executed by at least one processor, cause the at least one processor to perform the steps of generating a relaxed store message that comprises a first epoch number, incrementing a first counter associated with the first epoch number, and transmitting the relaxed store message to a first directory included in a cache.
13. The one or more non-transitory computer readable media of clause 12, wherein the instructions, when executed by the at least one processor, further cause the at least one processor to perform the steps of generating a release store message that comprises the first epoch number, the first counter, and a last unacknowledged epoch number, incrementing a stored epoch number, resetting the first counter, and transmitting the release store message to the first directory.
14. The one or more non-transitory computer readable media of clauses 12 or 13, wherein the first directory performs a release store operation based on the release store message only after (i) a second counter maintained by the first directory matches the first counter, and (ii) the last unacknowledged epoch number has been committed.
15. The one or more non-transitory computer readable media of any of clauses 12-14, wherein the release store message further comprises a second counter indicating a number of notifications that need to be received from one or more second directories included in the cache.
16. The one or more non-transitory computer readable media of any of clauses 12-15, wherein the instructions, when executed by the at least one processor, further cause the at least one processor to perform the step of transmitting, to each second directory included in the one or more second directories, a request to notify the first directory after the second directory commits one or more stores associated with the first epoch number.
17. The one or more non-transitory computer readable media of any of clauses 12-16, wherein the instructions, when executed by the at least one processor, further cause the at least one processor to perform the steps of generating another relaxed store message that comprises a second epoch number, incrementing a second counter associated with the second epoch number, and transmitting the another relaxed store message to the first directory.
18. The one or more non-transitory computer readable media of any of clauses 12-17, wherein the instructions, when executed by the at least one processor, further cause the at least one processor to perform the steps of receiving, from the first directory, an acknowledgement message associated with the release store message, and updating a data structure to indicate that the first epoch number has been acknowledged.
19. The one or more non-transitory computer readable media of any of clauses 12-18, wherein the instructions, when executed by the at least one processor, further cause the at least one processor to perform the step of prior to generating the release store message, determining that no source ordering requests are outstanding.
20. In some embodiments, a system comprises a cache that comprises a directory, and a processor, wherein, in operation, the processor generates a relaxed store message that comprises an epoch number, increments a counter associated with the epoch number, and transmits the relaxed store message to the directory.
1. In some embodiments, a computer-implemented method for inter-processor communication comprises receiving a relaxed store message that comprises a first epoch number, performing a relaxed store operation based on the relaxed store message, and incrementing a first counter associated with the first epoch number.
2. The computer-implemented method of clause 1, further comprising receiving a release store message that comprises the first epoch number, a second counter, and a last unacknowledged epoch number, and in response to determining that (i) the first counter matches the second counter, and (ii) the last unacknowledged epoch number has been committed, performing a release store operation based on the release store message.
3. The computer-implemented method of clauses 1 or 2, further comprising receiving a release store message that comprises the first epoch number, a second counter, and a last unacknowledged epoch number, and in response to determining that (i) the first counter does not match the second counter, or (ii) the last unacknowledged epoch number has not been committed, waiting either a predefined amount of time or until the first counter is updated.
4. The computer-implemented method of any of clauses 1-3, further comprising receiving a request for notification that comprises the first epoch number, a second counter, and a last unacknowledged epoch, and in response to determining that (i) the first counter matches the second counter, and (ii) the last unacknowledged epoch has been committed, transmitting a notification to a destination directory included in a cache.
5. The computer-implemented method of any of clauses 1-4, wherein the request for notification further specifies the destination directory.
6. The computer-implemented method of any of clauses 1-5, further comprising receiving, from a directory included in a cache, a notification that comprises the first epoch number, and incrementing a second counter associated with the first epoch number.
7. The computer-implemented method of any of clauses 1-6, wherein the first counter is associated with a processor that transmitted the relaxed store message.
8. The computer-implemented method of any of clauses 1-7, wherein performing the relaxed store operation comprises writing data included in the relaxed store message into a cache.
9. The computer-implemented method of any of clauses 1-8, wherein the cache is included in a hierarchy of caches that implement release consistency using directory ordering.
10. The computer-implemented method of any of clauses 1-9, wherein the relaxed store message is received from one of a central processing unit (CPU), a CPU core, graphics processing unit (GPU), or a GPU streaming multiprocessor.
11. In some embodiments, one or more non-transitory computer readable media include instructions that, when executed, cause a directory included in a cache to perform the steps of receiving a relaxed store message that comprises a first epoch number, performing a relaxed store operation based on the relaxed store message, and incrementing a first counter associated with the first epoch number.
12. The one or more non-transitory computer readable media of clause 11, wherein the instructions, when executed, further cause the directory to perform the steps of receiving a release store message that comprises the first epoch number, a second counter, and a last unacknowledged epoch number, and in response to determining that (i) the first counter matches the second counter, and (ii) the last unacknowledged epoch number has been committed, performing a release store operation based on the release store message.
13. The one or more non-transitory computer readable media of clauses 11 or 12, wherein the instructions, when executed, further cause the directory to perform the step of transmitting an acknowledgement message to a processor that transmitted the release store message.
14. The one or more non-transitory computer readable media of any of clauses 11-13, wherein the instructions, when executed, further cause the directory to perform the steps of receiving a release store message that comprises the first epoch number, a second counter, and a last unacknowledged epoch number, and in response to determining that (i) the first counter does not match the second counter, or (ii) the last unacknowledged epoch number has not been committed, waiting either a predefined amount of time or until the first counter is updated.
15. The one or more non-transitory computer readable media of any of clauses 11-14, wherein the instructions, when executed, further cause the directory to perform the steps of receiving another relaxed store message that comprises a second epoch number, performing another relaxed store operation based on the another relaxed store message, and incrementing a second counter associated with the second epoch number.
16. The one or more non-transitory computer readable media of any of clauses 11-15, wherein the instructions, when executed, further cause the directory to perform the steps of receiving a request for notification that comprises the first epoch number, a second counter, a last unacknowledged epoch, and a specification of a destination directory included in a cache, and in response to determining that (i) the first counter matches the second counter, and (ii) the last unacknowledged epoch has been committed, transmitting a notification to the destination directory.
17. The one or more non-transitory computer readable media of any of clauses 11-16, wherein the instructions, when executed, further cause the directory to perform the steps of receiving, from a directory included in a cache, a notification that comprises the first epoch number, and incrementing a second counter associated with the first epoch number.
18. The one or more non-transitory computer readable media of any of clauses 11-17, wherein the first counter is associated with a processor that transmitted the relaxed store message.
19. The one or more non-transitory computer readable media of any of clauses 11-18, wherein the directory is included in a slice of the cache.
20. In some embodiments, a system comprises a processor, and a cache that comprises a directory, wherein, in operation, the directory receives, from the processor, a relaxed store message that comprises an epoch number, performs a relaxed store operation based on the relaxed store message, and increments a counter associated with the epoch number.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and/or variations will be apparent to those of ordinary skill in the art without departing from the scope and/or spirit of the described embodiments.

Aspects of the present embodiments can be embodied as a system, method, or computer program product. Accordingly, aspects of the present disclosure can take the form of an entirely hardware embodiment, an entirely software embodiment (including firmware, resident software, micro-code, etc.) or an embodiment combining software and/or hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described herein with reference to flowchart illustrations and/or block diagrams of methods, apparatus (systems) and/or computer program products according to embodiments of the disclosure. It will be understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowcharts and/or block diagrams in the figures illustrate the architecture, functionality, and/or operation of possible implementations of systems, methods, and/or computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that perform the specified functions or acts, or combinations of special purpose hardware and/or computer instructions.

While the preceding is directed to embodiments of the present disclosure, other and/or further embodiments of the disclosure can be devised without departing from the basic scope thereof, and/or the scope thereof is determined by the claims that follow.

What is claimed is:

1. A computer-implemented method for inter-processor communication, the method comprising:
receiving a relaxed store message that comprises a first epoch number;
performing a relaxed store operation based on the relaxed store message; and
incrementing a first counter associated with the first epoch number.

2. The computer-implemented method of claim 1, further comprising:
receiving a release store message that comprises the first epoch number, a second counter, and a last unacknowledged epoch number; and
in response to determining that (i) the first counter matches the second counter, and (ii) the last unacknowledged epoch number has been committed, performing a release store operation based on the release store message.

3. The computer-implemented method of claim 1, further comprising:
receiving a release store message that comprises the first epoch number, a second counter, and a last unacknowledged epoch number; and
in response to determining that (i) the first counter does not match the second counter, or (ii) the last unacknowledged epoch number has not been committed, waiting either a predefined amount of time or until the first is updated.

4. The computer-implemented method of claim 1, further comprising:
receiving a request for notification that comprises the first epoch number, a second counter, and a last unacknowledged epoch; and
in response to determining that (i) the first counter matches the second counter, and (ii) the last unacknowledged epoch has been committed, transmitting a notification to a destination directory included in a cache.

5. The computer-implemented method of claim 4, wherein the request for notification further specifies the destination directory.

6. The computer-implemented method of claim 1, further comprising:
receiving, from a directory included in a cache, a notification that comprises the first epoch number; and
incrementing a second counter associated with the first epoch number.

7. The computer-implemented method of claim 1, wherein the first counter is associated with a processor that transmitted the relaxed store message.

8. The computer-implemented method of claim 1, wherein performing the relaxed store operation comprises writing data included in the relaxed store message into a cache.

9. The computer-implemented method of claim 8, wherein the cache is included in a hierarchy of caches that implement release consistency using directory ordering.

10. The computer-implemented method of claim 1, wherein the relaxed store message is received from one of a central processing unit (CPU), a CPU core, graphics processing unit (GPU), or a GPU streaming multiprocessor.

11. One or more non-transitory computer readable media including instructions that, when executed, cause a directory included in a cache to perform the steps of:
receiving a relaxed store message that comprises a first epoch number;
performing a relaxed store operation based on the relaxed store message; and
incrementing a first counter associated with the first epoch number.

12. The one or more non-transitory computer readable media of claim 11, wherein the instructions, when executed, further cause the directory to perform the steps of:
receiving a release store message that comprises the first epoch number, a second counter, and a last unacknowledged epoch number; and
in response to determining that (i) the first counter matches the second counter, and (ii) the last unacknowledged epoch number has been committed, performing a release store operation based on the release store message.

13. The one or more non-transitory computer readable media of claim 12, wherein the instructions, when executed, further cause the directory to perform the step of transmitting an acknowledgement message to a processor that transmitted the release store message.

14. The one or more non-transitory computer readable media of claim 11, wherein the instructions, when executed, further cause the directory to perform the steps of:
receiving a release store message that comprises the first epoch number, a second counter, and a last unacknowledged epoch number; and
in response to determining that (i) the first counter does not match the second counter, or (ii) the last unacknowledged epoch number has not been committed, waiting either a predefined amount of time or until the first is updated.

15. The one or more non-transitory computer readable media of claim 11, wherein the instructions, when executed, further cause the directory to perform the steps of:
receiving another relaxed store message that comprises a second epoch number;
performing another relaxed store operation based on the another relaxed store message; and
incrementing a second counter associated with the second epoch number.

16. The one or more non-transitory computer readable media of claim 11, wherein the instructions, when executed, further cause the directory to perform the steps of:
receiving a request for notification that comprises the first epoch number, a second counter, a last unacknowledged epoch, and a specification of a destination directory included in a cache; and
in response to determining that (i) the first counter matches the second counter, and (ii) the last unacknowledged epoch has been committed, transmitting a notification to the destination directory.

17. The one or more non-transitory computer readable media of claim 11, wherein the instructions, when executed, further cause the directory to perform the steps of:
receiving, from a directory included in a cache, a notification that comprises the first epoch number; and
incrementing a second counter associated with the first epoch number.

18. The one or more non-transitory computer readable media of claim 11, wherein the first counter is associated with a processor that transmitted the relaxed store message.

19. The one or more non-transitory computer readable media of claim 11, wherein the directory is included in a slice of the cache.

20. A system comprising:
a processor; and
a cache that comprises a directory, wherein, in operation, the directory:
receives, from the processor, a relaxed store message that comprises an epoch number,
performs a relaxed store operation based on the relaxed store message, and
increments a counter associated with the epoch number.
